(19) United States
(12) Patent Application Publication
(10) Pub. No.: US 2022/0067698 A1
(43) Pub. Date: Mar. 3, 2022

(54) WIRELESS PAYMENT SYSTEMS, DEVICES AND METHODS FOR ELECTRONIC PAYMENT

(71) Applicant: Perk Hero Software Inc., Vancouver (CA)

(72) Inventors: Desmond Griffin, Vancouver (CA); Angela Griffin, Vancouver (CA); Jian Qun Zhang, Maple Ridge (CA); Norman Tan, Richmond (CA); Jonathan Hoyles, Vancouver (CA)

(21) Appl. No.: 17/521,764

(22) Filed: Nov. 8, 2021

Related U.S. Application Data
(63) Continuation-in-part of application No. 16/493,139, filed on Sep. 11, 2019, now Pat. No. 11,170,354.
(60) Provisional application No. 62/472,288, filed on Mar. 16, 2017.

(51) Int. Cl. G06Q 20/32; G06Q 20/40; G06Q 20/10

(52) U.S. Cl. CPC G06Q 20/3278; G06Q 20/3276; G06Q 20/102; G06Q 20/405; G06Q 20/4014

(57) ABSTRACT

Wireless payment systems and methods for electronic payment of bills are provided. In one example, a digital image of a bill and a location of a user device at a time at which the digital image was captured are received by a service provider server. A merchant is determined based on the location of the user device at the time at which the digital image was captured. A merchant-specific bill format of the bill is determined for the merchant. A billed amount is determined by analyzing the digital image using intelligent optical character recognition based on the merchant-specific bill format of the bill. Payment and optionally reward point processing is subsequent performed.

### RELATED APPLICATION DATA

The present application is a continuation-in-part of U.S. patent application Ser. No. 16/493,139, filed Mar. 12, 2018, which claims priority to provisional U.S. patent application No. 62/472,288, filed Mar. 16, 2017, the content of both documents being incorporated herein by reference.

### TECHNICAL FIELD

The present application is directed to electronic payments, and in particular, to wireless payment systems, devices and methods for electronic payment of bills or invoices.

### BACKGROUND

Traditional bill payment systems in merchant establishments, such as restaurants, typically require a customer to pay by cash or by using a payment machine for a credit card or debit card. The payment machine may require a customer to either go to the payment machine or rely on a staff member to bring a wireless payment machine to the customer. The payment machines may be limited in number and may not be secure for the transmission of credit or debit card and personal information.

### SUMMARY

The present disclosure provides wireless payment systems, devices and methods for electronic payment of bills or invoices. The described wireless payment systems, devices and methods enable a user to create an electronic transaction for payment of a bill or invoice associated with a merchant without physically interacting with a payment machine of the merchant. In some embodiments, the user (e.g., customer) captures an image of the bill with a wireless communications device (e.g., smartphone) and sends the image to a server operated by an electronic transaction service provider. The service provider server analyzes the captured image to determine at least the amount billed and the merchant establishment associated with the bill. The server sends a request to the user to confirm at least the payment of the billed amount. The user may confirm the merchant establishment and billed amount. The user may optionally take other steps such as to add a tip to the billed amount or to pay only a portion of the billed amount, depending on the merchant establishment, for example, based on merchant establishment rules associated with the merchant establishment. Upon receipt of confirmation from the user, the server processes payment to charge or deduct the confirmed amount from a user account associated with the user and to provide payment to the merchant establishment. The server may also send a notification to the merchant establishment and/or to a staff person associated with the bill to confirm payment of the bill.

Thus, the user may pay a bill through the use of their wireless communication device without having to wait for the use of a point of sale (POS) terminal provided by the merchant establishment. Payment is made using an account securely maintained by the service provider and without the user providing credit card information to the merchant or a third party in an unsecured or less secure environment of the merchant establishment. While other software applications exist to facilitate payment for goods or services, these may require a significant level of integration with the payment or POS system used by the merchant establishment. The methods, devices and systems described herein may also be used by a merchant that does not have a POS system.

In accordance with a first aspect of the present disclosure, there is provided a computer-implemented method of electronic bill payment, comprising: receiving, by a server from a wireless communication device, a digital image of a bill captured by a digital camera of the wireless communication device, and a location of the wireless communication device at a time at which the digital image was captured; determining, by the server, a merchant based on the location of the wireless communication device at the time at which the digital image was captured; determining, by the server, a merchant-specific bill format of the bill for the merchant; determining, by the server, a billed amount by analyzing the digital image using intelligent optical character recognition (OCR) based on the merchant-specific bill format of the bill; determining, by the server, a user account associated with the wireless communication device based on a user ID associated with a user of the wireless communication device, the user ID received from the wireless communication device; generating, by the server, a request for user input confirming payment of the bill based on the billed amount, wherein the request causes a visual user interface (VUI) screen to be displayed on a display of the wireless communication device, the VUI including an element for receiving user input for confirming payment of the bill; sending, by the server, the request to the wireless communication device; receiving, by the server, user input confirming payment of the bill from the wireless communication device, the user input indicating a payment amount; generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the payment information associated with the user account and the merchant are maintained by the server the merchant maintained by the server; and causing the electronic payment transaction to be performed.

In some or all embodiments of the first aspect, the merchant-specific bill format of the bill is based on the merchant and the location of the wireless communication device at the time at which the digital image was captured.

In some or all embodiments of the first aspect, determining, by the server, the billed amount by analyzing the digital image using intelligent OCR based on the merchant-specific bill format of the bill, comprises: converting, by applying OCR, the digital image into a plurality of cells, each cell comprising text; and selecting a value of a cell in the plurality of cells as the billed amount based on a designated cell in accordance with the merchant-specific bill format.

In some or all embodiments of the first aspect, the cells generated by applying OCR are arranged by rows and columns, wherein designated cell is defined by row and column.

In some or all embodiments of the first aspect, the location comprises a global positioning system (GPS) location of the wireless communication device, a location of the wireless communication device in cellular communications network, a micro-location of the wireless communication device in a retail location associated with the retailer, an identifier associated with the retail location, a user selected location, or a combination of two or more thereof.

In accordance with a second aspect of the present disclosure, there is provided a computer-implemented method of electronic bill payment, comprising: receiving, by a server from a wireless communication device, a digital image of a bill captured by a digital camera of the wireless communication device, and a merchant identifier (ID) associated with a merchant; determining, by the server, a billed amount by analyzing the digital image using optical character recognition (OCR) by identifying a set of all numbers present in the bill, generating a subset of numbers by removing numbers above a threshold from the set of all number present in the bill, and selecting the highest number from the subset of numbers as the billed amount; determining, by the server, a user account associated with the wireless communication device based on a user ID associated with a user of the wireless communication device, the user ID received from the wireless communication device; determining a merchant account associated with the merchant ID; generating, by the server, a request for user input confirming payment of the bill based on the billed amount, wherein the request causes a visual user interface (VUI) screen to be displayed on a display of the wireless communication device, the VUI including an element for receiving user input for confirming payment of the bill; sending, by the server, the request to the wireless communication device; receiving, by the server, user input confirming payment of the bill from the wireless communication device, the user input indicating a payment amount; generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the payment information associated with the user account and the merchant are maintained by the server the merchant maintained by the server; and causing the electronic payment transaction to be performed.

In some or all embodiments of the second aspect, the threshold is based on a merchant type.

In some or all embodiments of the second aspect, the method further comprises: determining a merchant type based on the merchant ID.

In accordance with a third aspect of the present disclosure, there is provided a computer-implemented method of electronic bill payment, comprising: receiving, by a server from a wireless communication device, a digital image of a bill captured by a digital camera of the wireless communication device, and a merchant identifier (ID) associated with a merchant; determining, by the server, a billed amount and a location of a merchant establishment associated with the merchant by converting the digital image into a plurality of cells applying intelligent optical character recognition (OCR), each cell comprising text, selecting a value of a cell in the plurality of cells as the billed amount based on a first designated cell in accordance with a merchant-specific bill format of the bill, and selecting a value of a cell in the plurality of cells as the location of the merchant establishment based on a second designated cell in accordance with the merchant-specific bill format of the bill; determining, by the server, a user account associated with the wireless communication device based on a user ID associated with a user of the wireless communication device, the user ID received from the wireless communication device; determining a merchant account associated with the merchant ID; generating, by the server, a request for user input confirming payment of the bill based on the billed amount and the location determined from the bill, wherein the request causes a visual user interface (VUI) screen to be displayed on a display of the wireless communication device, the VUI including an element for receiving user input for confirming payment of the bill; sending, by the server, the request to the wireless communication device; receiving, by the server, user input confirming payment of the bill from the wireless communication device, the user input indicating a payment amount; generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the electronic payment instruction includes the location of the merchant establishment determined from the bill, wherein the payment information associated with the user account and the merchant are maintained by the server the merchant maintained by the server; and causing the electronic payment transaction to be performed.

In some or all embodiments of the foregoing aspects, the VUI comprises an element for specifying the payment amount from a plurality of payment options, wherein the plurality of payment options include a portion of a billed amount and an amount of a tip to be added to the billed amount based on the portion of the billed amount to be paid.

In some or all embodiments of the foregoing aspects, the method further comprises: determining merchant rules or merchant establishment rules for the merchant; wherein the VUI only comprises the element for specifying the payment amount from a plurality of payment options in response to a matching merchant establishment rule.

In some or all embodiments of the foregoing aspects, the merchant establishment rules are based on the merchant and the location of a merchant establishment associated with bill.

In some or all embodiments of the foregoing aspects, causing the electronic payment transaction to be performed comprises: executing the electronic payment transaction.

In some or all embodiments of the foregoing aspects, causing the electronic payment transaction to be performed comprises: sending the electronic payment instruction to a payment processor for execution.

In some or all embodiments of the foregoing aspects, the method further comprises: sending a notification to the merchant confirming payment of the bill.

In some or all embodiments of the foregoing aspects, sending the notification to the merchant comprises sending an electronic message to a wireless communication device of a staff person associated with the bill.

In some or all embodiments of the foregoing aspects, the staff person associated with the bill is determined by performing intelligent OCR based on the merchant-specific bill format of the bill.

In some or all embodiments of the foregoing aspects, the method further comprises: subsequent to completion of the electronic payment transaction: determining, by the server, a reward accumulation rate for the user account based on the user ID; determining, by the server, a reward amount based on the payment amount and the reward accumulation rate; generating, by the server, a reward transaction instruction based on the user ID and the reward amount; and causing the reward transaction to be performed.

In some or all embodiments of the foregoing aspects, the reward accumulation rate is based a progression level.

In some or all embodiments of the foregoing aspects, the reward accumulation rate is based on the progression level and a purchase type.

In accordance with a fourth aspect of the present disclosure, there is provided a method of creating an electronic payment transaction comprising: receiving an image of a bill; analyzing the received image to determine at least a billed amount; determining a merchant associated with the billed amount; sending a request to a user to confirm at least the billed amount; and in response to receiving confirmation from the user of a confirmed payment amount, creating an electronic payment transaction to deduct the confirmed payment amount from an account associated with the user and to provide a payment to an account associated with the merchant for the confirmed amount.

In some or all embodiments of the fourth aspect, the method further comprises sending a notification to the merchant confirming payment of the bill.

In some or all embodiments of the fourth aspect, analyzing the received image further comprises analyzing the received image to determine a staff person associated with the bill, and wherein sending the notification to the merchant comprises sending an email message to the associated staff person.

In some or all embodiments of the fourth aspect, receiving the image of the bill comprises receiving a photograph of the bill from a wireless communications device associated with the user.

In some or all embodiments of the fourth aspect, determining the merchant associated with the billed amount comprises analyzing the received image for bill format information and/or identifiers associated with the merchant, and determining the merchant based on the bill format information and/or identifiers.

In some or all embodiments of the fourth aspect, determining the merchant associated with the billed amount comprises receiving location information from a wireless communications device associated with the user, and determining the merchant based on the received location information, the received image, or a combination of the received location information and the received image.

In some or all embodiments of the fourth aspect, the location information comprises a global positioning system (GPS) location of the wireless communications device, a location of the wireless communications device in cellular communications network, a micro-location of the wireless communications device in a retail location associated with the merchant, an identifier associated with the retail location, a user selected location, or a combination of two or more thereof.

In some or all embodiments of the fourth aspect, analyzing the image further comprises identifying information from the image based on a bill format associated with the merchant.

In some or all embodiments of the fourth aspect, the image of the bill comprises a photograph of a paper bill captured by the wireless communications device.

In some or all embodiments of the fourth aspect, the confirmed payment amount is the same as the billed amount, is a portion of the billed amount, or exceeds the billed amount.

In some or all embodiments of the fourth aspect, sending the request to the user comprises sending a request to confirm the billed amount and the merchant associated with the billed amount.

In some or all embodiments of the fourth aspect, the method further comprises executing the electronic payment transaction.

In accordance with a fifth aspect of the present disclosure, there is provided a computer-implemented electronic payment method, comprising: receiving, by a server from a wireless communication device, one or more beacon signals of one or more short distance transmitters (SDTs) received by the wireless communication device and global positioning system (GPS) information indicating a location of the wireless communication device; determining, by the server, a SDT nearest to the wireless communication device based on the one or more beacon signals and GPS information; determining, by the server, a bill associated with the wireless communication device based on the SDT, each SDT in a plurality of SDTs being associated with a bill, one bill at a time; determining, by the server, a user account associated with the wireless communication device; obtaining, by the server from a point of sale (POS) system of a merchant, bill information for the bill, wherein the POS system maintains bill information for a plurality of SDTs; generating, by the server, a request for user input confirming payment of the bill based on the bill information and payment information associated with the user account maintained by the server, wherein the request causes a visual user interface (VUI) screen to be displayed on a display of the wireless communication device, the VUI including an element for receiving user input for confirming payment of the bill; sending, by the server, the request to the wireless communication device; receiving, by the server, user input confirming payment of the bill from the wireless communication device, the user input indicating a payment amount; generating, by the server, an electronic payment instruction in response to receiving user input confirming payment of the bill from the wireless communication device, the electronic payment instruction being based on payment information associated with the user account maintained by the server, financial payment information associated with a merchant account associated with the merchant maintained by the server, and the payment amount; and causing the electronic payment transaction to be performed.

In some or all embodiments of the fifth aspect, the SDTs and one or more beacon signals use micro-location technology.

In some or all embodiments of the fifth aspect, the SDT nearest to the wireless communication device is determined by the server using a triangulation or trilateration process.

In some or all embodiments of the fifth aspect, the one or more beacon signals each include an identifier associated with a respective SDT.

In some or all embodiments of the fifth aspect, the SDT nearest to the wireless communication device is determined by comparing a strength, frequency and/or content of the one or more beacon signals.

In some or all embodiments of the fifth aspect, the SDT nearest to the wireless communication device is determined by identifying the beacon signal having the strongest signal, and determining an identifier of the SDT from the beacon signal having the strongest signal, wherein the SDT nearest to the wireless communication device is determined from the identifier of the SDT having the strongest signal.

In some or all embodiments of the fifth aspect, the SDT nearest to the wireless communication device is determined by the server based on the one or more beacon signals, GPS information and scan data.

In some or all embodiments of the fifth aspect, the scan data comprises a Quick Response (QR) code.

In some or all embodiments of the fifth aspect, causing the electronic payment transaction to be performed comprises executing the electronic payment transaction.

In some or all embodiments of the fifth aspect, causing the electronic payment transaction to be performed comprises: sending the electronic payment instruction to a payment processor for execution.

In some or all embodiments of the fifth aspect, the VUI comprises an element for specifying the payment amount from a plurality of payment options, wherein the plurality of payment options include a portion of a billed amount and an amount of a tip to be added to the billed amount based on the portion of the billed amount to be paid.

In some or all embodiments of the fifth aspect, the SDTs and one or more beacon signals use the iBeacon communication protocol.

In some or all embodiments of the fifth aspect, the method further comprise sending a notification to the merchant confirming payment of the bill.

In some or all embodiments of the fifth aspect, sending the notification to the merchant comprises sending an electronic message to a wireless communication device of a staff person associated with the bill.

In accordance with a sixth aspect of the present disclosure, there is provided a method of creating an electronic payment transaction, comprising: receiving location information of a wireless communication device; obtaining billing information of a user associated with the wireless communication device from a merchant according to the location information; sending a request to the user to confirm a payment amount; and in response to receiving confirmation from the user of a confirmed payment amount, creating an electronic payment transaction to deduct the confirmed payment amount from an account associated with the user and to provide a payment to an account associated with the merchant for the confirmed amount.

In some or all embodiments of the sixth aspect, the method further comprises prior to obtaining billing information of the user, correlating location information of the wireless communication device with a mapping or grid location information for determining a location within the merchant.

In some or all embodiments of the sixth aspect, the location information of the wireless communication device is determined by using near-field communications or micro-location technologies.

In some or all embodiments of the sixth aspect, the location information of the wireless communication device indicates a specific location or position of the wireless communication device within the merchant.

In some or all embodiments of the sixth aspect, the specific location is determined by the wireless communication device or a server using a triangulation or trilateration process.

In some or all embodiments of the sixth aspect, the location information indicates a table and seat number associated with the user.

In some or all embodiments of the sixth aspect, the location information is determined according to beacon signals of short distance transmitters received by the wireless communication device.

In some or all embodiments of the sixth aspect, the location information includes GPS coordinates of the wireless communication device or the user selecting a specific retail location.

In some or all embodiments of the sixth aspect, the billing information is obtained from a Point of Sale (POS) system of the merchant.

In some or all embodiments of the sixth aspect, a Point of Sale (POS) system transmits the billing information to the wireless communication device, and wherein a server obtains the billing information from the wireless communication device.

In some or all embodiments of the sixth aspect, the POS system includes a short distance transmitter that is nearest to the wireless communication device.

In some or all embodiments of the sixth aspect, the POS system transmits the billing information to the wireless communication device using Bluetooth™.

In some or all embodiments of the sixth aspect, the method further comprises prior to sending the request to the user, verifying the wireless communication device is associated with a valid retail account.

In some or all embodiments of the sixth aspect, the billing information is obtained from a staff device of the merchant.

In some or all embodiments of the sixth aspect, the method further comprises sending a notification to the merchant confirming payment of the bill.

In some or all embodiments of the sixth aspect, sending the notification to the merchant comprises sending an email message to the associated staff person.

In some or all embodiments of the sixth aspect, the location information includes the identifier of a short distance transmitter placed at a predetermined location.

In accordance with another aspect of the present disclosure, there is provided a computing device comprising one or more processors and a memory, the memory having tangibly stored thereon executable instructions for execution by the one or more processors. The executable instructions, in response to execution by the one or more processors, cause the one or more processors to perform the methods described above and herein.

In accordance with a further aspect of the present disclosure, there is provided a non-transitory machine-readable storage medium having tangibly stored thereon executable instructions for execution by one or more processors of a computing device. The executable instructions, in response to execution by the one or more processors, cause the one or more processors and computing device to perform the methods described above and herein.

Other aspects and features of the present disclosure will become apparent to those of ordinary skill in the art upon review of the following description of specific implementations.

### BRIEF DESCRIPTION OF THE DRAWINGS

FIG. 1 is a block diagram illustrating a system in accordance with an example embodiment of the present disclosure.

FIG. 2 is a flowchart of a computer-implemented electronic payment in accordance with an example embodiment of the present disclosure.

FIG. 3 is a flowchart of a method in accordance with an example embodiment of the present disclosure.

FIGS. 4(a) to 4(d) are example visual user interface screens in accordance with an example embodiment of the present disclosure.

FIG. 5 is a block diagram illustrating a system in accordance with an example embodiment of the present disclosure.

FIG. 6 is a flowchart of a computer-implemented electronic payment in accordance with another example embodiment of the present disclosure.

FIG. 7 is a flowchart of a computer-implemented electronic payment in accordance with another example embodiment of the present disclosure.

FIG. 8 is a block diagram of an example wireless communication device in accordance with the present disclosure.

FIG. 9 is a schematic block diagram of a server in accordance with the present disclosure.

FIG. 10 is a block diagram of a subset of the functional components of the server in accordance with the present disclosure.

FIG. 11 is a schematic block diagram of a wireless payment system in accordance with the present disclosure.

FIG. 12 is a flowchart of a computer-implemented method of electronic bill payment in accordance with another embodiment of the present disclosure.

FIG. 13 is a flowchart of a computer-implemented method of electronic bill payment in accordance with another embodiment of the present disclosure.

FIG. 14 is a flowchart of a computer-implemented method of electronic bill payment in accordance with another embodiment of the present disclosure.

FIG. 15 is an example home screen of a visual user interface of a user device in accordance with an example embodiment of the present disclosure.

FIG. 16 is an example restaurant screen of a visual user interface of a user device in accordance with an example embodiment of the present disclosure.

FIG. 17 is an example parking ticket screen of a visual user interface of a user device in accordance with an example embodiment of the present disclosure.

FIG. 18 is an example payment screen of a visual user interface of a user device in accordance with an example embodiment of the present disclosure

### DETAILED DESCRIPTION OF EXAMPLE EMBODIMENTS

The present disclosure is made with reference to the accompanying drawings, in which embodiments of technical solutions are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable storage medium. Lastly, elements referred to in the singular may be plural and vice versa, except where indicated otherwise either explicitly or inherently by context.

Within the present disclosure, the following sets of terms may be used interchangeably: bill and invoice, merchant and retailer, and user and customer. For the purpose of the present disclosure, real-time means that a computing operation or process is completed within a relatively short maximum duration, typically milliseconds or microseconds, fast enough to affect the environment in which the computing operation or process occurs, such as the inputs to a computing system.

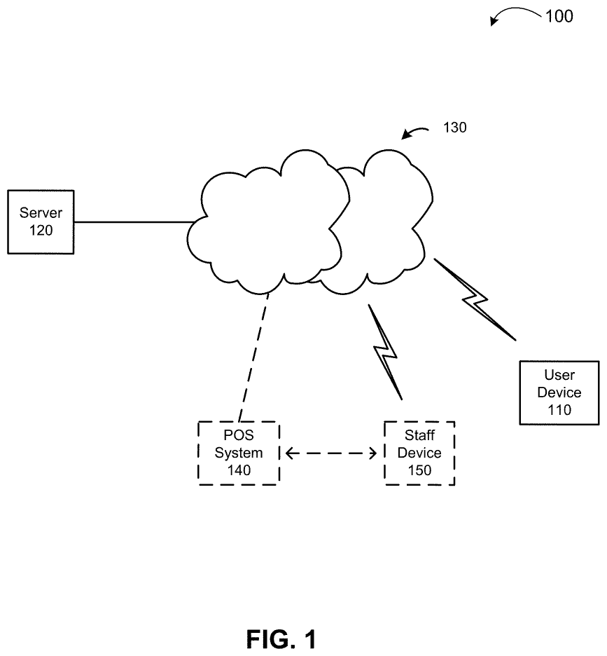

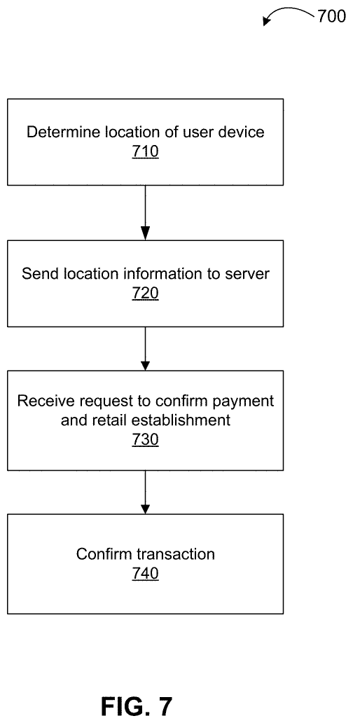

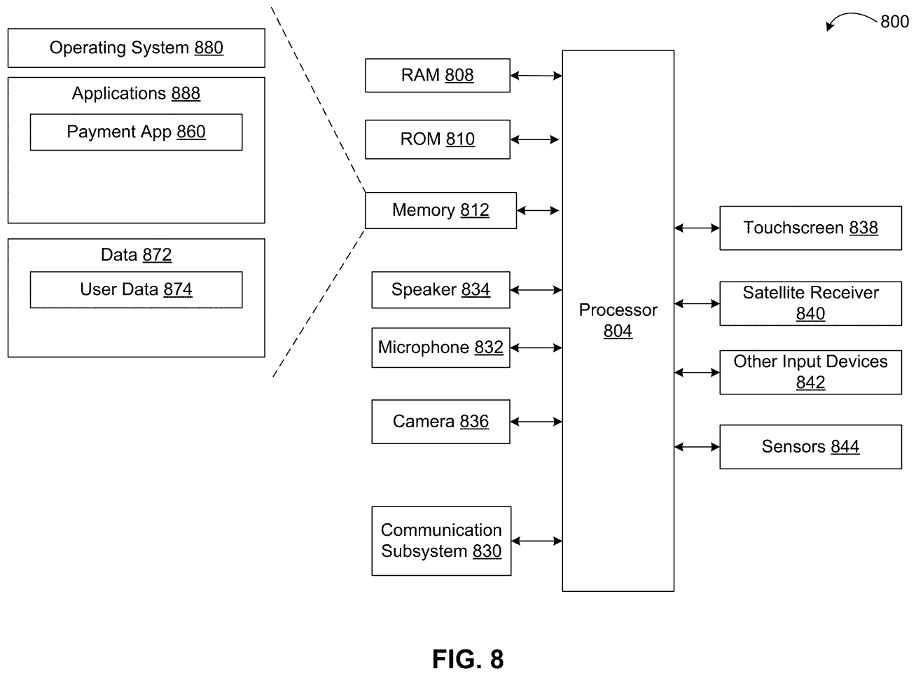

FIG. 1 illustrates a wireless payment system 100 according to one embodiment of the present disclosure. The system includes one or more user devices 110 (FIG. 8) in the form of wireless communication devices 800 which are used by users 101 to capture and send an image of a bill to a server 120 (FIG. 9) of an electronic transaction service provider. The wireless communication device 800 has a processor 804 and a memory 812 configured to store and execute instructions (e.g., payment application 860) for the electronic transaction software applications described herein. The wireless communication device 800 is configured to support wireless communications and a user interface with a touchscreen 838 or other display device and other inputs/outputs such as a buttons, speakers, etc. The wireless communication device 800 also includes a camera 836 or other image capture device such as a scanner which is configured to capture and create a digital image or other electronic representation of a bill. The wireless communication device 800 may be a mobile phone, cellular phone, smart phone, tablet, smart watch, or other wireless communications device.

The communications between the wireless communication devices 800 and server 120 are achieved through a communications network 130. The communication network 130 may comprise one or a plurality of networks of one or more network types coupled via appropriate methods known in the art such as a LAN, a WLAN such as Wi-Fi™, a wireless personal area network (WPAN) such as Bluetooth™ based WPAN, a wide area network (WAN), a public-switched telephone network (PSTN), or a public-land mobile network (PLMN), also referred to as a wireless wide area network (WWAN) or a cellular network. The WLAN may include a wireless network which conforms to IEEE 802.11x standards or other communication protocol, or combinations thereof, including the Internet and related backbone networks (not shown).

The wireless payment system 100 may include a POS system 140 or other computing device of the merchant establishment which is used, for example, to track orders received from customers, to issue bills, to accept payments via wired or wireless payment machines, or to provide a combination of these functions. The POS system 140 also may communicate with the server 120 through the network 130. In some embodiments, there may be additional staff devices 150 associated with the staff of the merchant establishment. The staff devices 150 may be wireless communication devices 800 similar to user devices 110 and may receive wireless communications from the server 120 of the electronic transaction service provider. Alternatively or additionally, the staff devices 150 may be part of the POS system 140 and/or may exchange communications with the POS system 140. Each of the POS system 140 and staff device 150 includes a processor and a memory configured to store and execute instructions for the electronic transaction software applications described herein. Each of the POS system 140 and the staff device 150 is configured to support wired and/or wireless communications and may include a user interface with a display screen, keypad or buttons, and other inputs/outputs.

To receive the services described herein, a user creates a customer account with the electronic transaction service provider and receives a user software application to be executed by their user device 110 to carry out the methods described herein. The user typically provides personal information to the electronic transaction service provider, for example, to the server 120, which can be used to identify and authenticate the user, such as one or more telephone numbers, addresses, passwords, user names, identifiers associated with the user's user device 110, or combinations thereof. With the personal information provided a user, the server 120 associates the user with the user's user device 110. The user also typically provides data for at least one financial account or instrument such as a credit card, debit card, bank, online currency or other account, which is used to provide payments authorized by the user. The customer account may be created at any time through the network 130. It will be appreciated that a user may choose to create an account at a time when the user has secure access to the network 130, such as through a home network or other interface with greater security than, for example, an unrestricted or free public WLAN. In some embodiments, the user may enter or select one or more preferences associated with the customer account and electronic transaction services. Such preferences may include, for example, preferred payment tips, tip percentage preferences, and reward point (or loyalty point) accounts or information.

The merchant establishment creates a retail account with the electronic transaction service provider, for example, with the server 120. Example embodiments are described herein for a merchant establishment such as a restaurant, café, bar, lounge or other establishment providing food and/or beverage services. It will be appreciated, however, that the embodiments described herein are not limited to a particular type of merchant or merchant establishment or to a particular type of goods or services. The systems and methods described herein may be used for any merchant, merchant establishment, or business that provides printed or paper bills or invoices to customers. In some embodiments, the bill may be displayed in another system or medium, such as on a computer, terminal or other display and the image of the bill may be captured or photographed from that display. The merchant establishments or merchants may have a temporary or permanent site or structure and also may include, for example, food trucks, pop-up restaurants, retail clothing stores, special events or markets. The embodiments described herein may be used to create an electronic payment transaction for a bill received by a customer for goods/services received by the customer and for which immediate payment is required or preferred.

The merchant establishment provides information to the electronic transaction service provider, such as the server 120, consisting of contact information and banking or financial account information which enables the electronic transaction service provider to provide payments from the users and customer accounts to the retail account. A separate retail account may be created for each location of a merchant establishment. Alternatively, one account may be created for a merchant establishment with different banking information provided for each location of that establishment.

The merchant establishment also may provide sample bills or invoices and/or an indication of a bill format or standard to the electronic transaction service provider. This information may be provided when the retail account is created, or at a later date, and also may be updated by the merchant establishment as bills or formats change. The merchant establishment also may provide other information to the electronic transaction service provider, for example the server 120, including for example, location information and/or identifiers for the merchant or establishment, or for tables or other specific sites at each location of the merchant establishment. The merchant establishment also may provide staff identifiers, which may be associated with and/or displayed on a bill, and/or email addresses associated with the staff and staff devices 150 to the server 120. The sample bills or invoices, and format or other information may be used by the server 120 to determine a bill format associated with the merchant establishment and to improve the analysis of bills scanned and submitted by users, as described below.

The merchant establishment also may receive a software application to be executed by the POS system 140 and/or a software application for execution by staff devices 150 to carry out the methods described herein. As such, the POS system 140 and/or the staff device 150 may communicate with electronic transaction service provider, such as the server 120. In an example, the server 120 may access the POS system 140 and/or the staff device 150 to retrieve the information related to a payment of an invoice related to a user device 110. The retail account may include contact information, such as email addresses, telephone numbers or messaging system identifiers, for the merchant establishment and its staff. Thus, in some embodiments, additional software applications and/or integration of the POS system 140 with the wireless payment system 100 is not required. The merchant establishment and/or its staff may simply receive notification by an email, text or other message that a bill has been paid.

The information received and/or created for each customer and retail account may be encrypted and securely stored by the server 120. The server 120 is configured to maintain the accounts and exchange messages with the user device 110, staff devices 150 and POS systems 140. The server 120 includes a communications interface, a processor and a memory configured to store and execute instructions for the software applications and functions described herein. While shown as a single entity, the server 120 may consist of multiple processing, storage and communication devices and interfaces configured to carry out the functions described herein. The server 120 also is configured to exchange messages or instructions electronically with one or more financial institutions (not illustrated in FIG. 1) in order to effect and resolve payments between customer accounts and the bank accounts for one or more locations of the merchant establishment.

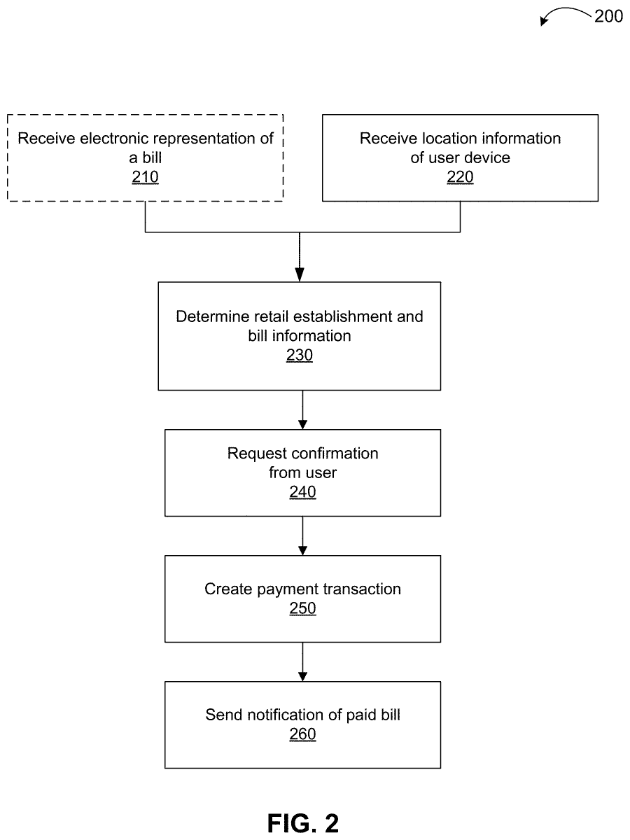

FIG. 2 illustrates one embodiment of a method 200 provided by the server 120 of an electronic transaction service provider. The server 120 receives an electronic representation of a bill (step 210) from a user device 110. The electronic representation is typically an electronic image or photograph of the bill which has been captured and transmitted by a user and the electronic transaction software application executed by the user device 110. A customer account number or other identifier associated with the user is also received by the server. In some cases, the server 120 may prompt the user device 110 to provide additional authentication information for the user in order to ensure access to the user's account, and payment authority provided through the electronic transaction application, remain secure.

The server 120 may receive (step 220) additional or extrinsic information from the user device 110 which may be used to identify the format of the bill. When the electronic transaction application is initiated on the user device 110, it may determine a location of the user device 110 using one or more technologies or other applications supported by the user device 110. The location information may include, for example, global positioning system (GPS) information, location information based on a cell or telecommunications coverage area in which the user device 110 is located, location information based on a WLAN network, identifiers or detailed location information about the user device 110 within a location of the merchant establishment, as described below, or combinations thereof. The location information of the user device 110 may be transmitted to the server 120 separately or along with the electronic representation of the bill.

The server 120 analyzes the received image to determine the format of the bill and/or the merchant establishment associated with the bill (step 230). This determination may be based on the received image and sample invoices or bills, format information and other information previously provided to the server 120; past processing of other bills from the same merchant establishment; past processing of similar bill formats from other merchant establishments; location information and/or identifiers provided by the user device 110; or combinations of this information. The information displayed on the bill may be computer-generated or hand-printed and may be captured using optical character recognition (OCR) and/or intelligent character recognition (ICR) techniques.

By using additional information which is provided by the user device 110, available from the retail account, and/or known from past bill processing, the capture of information from the image of the bill by the server 120 may be improved. Common patterns from prior OCR scanning results thus may be used by the server 120 to customize OCR algorithms to improve recognition accuracy for a particular bill format which is associated with a particular location and/or merchant. It will be appreciated that OCR scanning results may vary, particularly if the information is captured from photographs which vary in lighting and quality. If the associated or expected bill format has been determined for a particular image, then the scanning by the server 120 may be modified or verified for information which is expected to be provided in a certain location on the bill. For example, the server 120 may process an image but have results such as “table number” missing. If the server 120 has learned that the table number should be the third number that results from a scan for the given bill format, the table number may still be identified from the image sent from the user device 110.

The amount due for the bill and other information also may be determined or identified and captured from the image. This information is digitized as needed and retained by the server 120. The retained information may include a bill number; the merchant establishment name, account and/or location identifier; an amount owed to the merchant establishment; a table number or other site identifier; the name and/or number of a staff person such as a waiter or server associated with the bill or table; a till number; a product or service identifier; or combinations thereof.

After information is determined for the bill, the server 120 creates and sends a request to the user device 110 (step 240) to confirm payment of the bill. The request to the user device 110 may include the name and location of the merchant establishment and the amount to be paid for the bill. In some embodiments, the request may provide a suggested tip to be added to the bill based on the preferences stored for the customer account associated with the user. In some embodiments, the request displayed to the user may enable a user to pay only a portion of the bill based on a percentage or dollar amount.

After confirmation is received from the wireless communication device to proceed with payment, the server 120 causes an electronic payment transaction to occur (step 250) so that payment for the confirmed amount of the bill is deducted from the customer account associated with the user and credited to the retail account associated with the merchant establishment. The server 120 may not retain or provide funds to either the customer or merchant establishment. Instead, the server 120 securely requests and authorizes the appropriate payment or credit transactions between the financial account of the customer, and the bank or financial account associated with the merchant establishment or a specific location of the merchant establishment. It will be appreciated that the server 120 also may be configured to support other types of payment transactions such as a deduction from a customer's rewards account and a corresponding update or notification to the retail account when a customer redeems rewards points, coupons, promotional offers etc. In some embodiments, the payment is processed in real time to effect payment directly between the customer or user and the merchant establishment. In other embodiments deductions from a customer account and/or payments to a retail account may be grouped for processing later in order to reduce processing costs.

The server 120 may send a confirmation to the user device 110 to confirm that the instructions have been received and the payment has been processed. The user may be provided with a confirmation number or other identifier in order to track the transaction. In some embodiments, the method 200 includes the server 120 sending a notification to the merchant establishment (step 260) that the bill has been paid. This notification may consist of an email, text or other message to the staff associated with a particular bill and merchant establishment to confirm that the bill has been paid. The bill may be identified by a bill number, table number, or a staff name or number, till number, product identifier, a confirmation number, transaction number, or a combination thereof. If the staff person has a staff device 150 configured with the electronic transaction software application described herein, the notification may be provided through a screen display and/or other interface or indicator on the staff device 150, such as an audible alert, flashing light or vibration of the device. Similarly, if the POS system 140 is configured with the electronic transaction software application described herein, the notification may be provided through a screen display or other interface and/or alert on the POS system 140. In some embodiments, the notifications to each staff device 150 and to the POS system 140 may be customized to each particular staff member, or to provide a summary for the tables or sites and bills associated with the POS system 140 and each staff device 150.

In some embodiments, the amount confirmed by a user for the bill and paid by the server 120 at step 250, may be greater or less than the amount of the bill generated by the merchant establishment. The difference may be caused by many factors such as a tip being added to the bill, or a user paying only their portion of the bill, as noted above, or a user confirming payment of an incorrect amount. In some embodiments, the users or staff of the merchant establishment may request a change by the service provider in the amount which has been paid under the transaction. In some embodiments, the server 120 may be configured to accept and cause multiple payments for the same bill from multiple users executing the electronic transaction software applications described herein. Each user may scan and send the same bill and authorize payment of his or her portion of the bill. In other embodiments, the server 120 may notify the staff person and/or merchant establishment associated with the bill that payment has been received but the complete bill or total amount owed has not been paid.

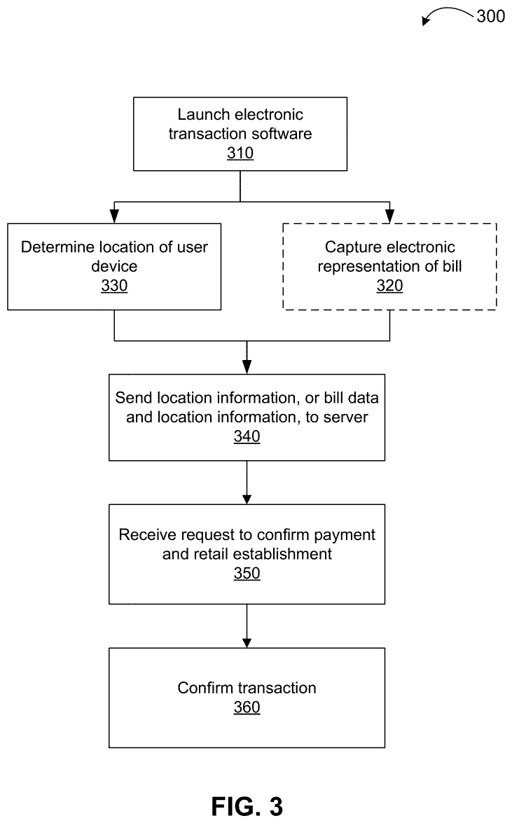

FIG. 3 illustrates a method 300 executed by a user device 110 according to embodiments described herein. The method includes the user device 110 receiving an instruction from a user to launch the electronic transaction software application (step 310). The user device 110 and software application enable the user to create an electronic representation of a bill received from a merchant establishment (step 320). The bill may be photographed or scanned using the user device 110. At the same time as capturing the image of the bill, or when the application is first launched, or periodically thereafter, the electronic transaction software application causes the user device 110 to determine a location (step 330) of the user device 110. The location may be determined using GPS information; information based on a cell, telecommunications coverage area, or WLAN area in which the user device 110 is located; detailed or “micro-location” information received or determined by the user device 110 within a location of the merchant establishment; or combinations thereof. In some embodiments, the location of the user device 110 may be determined by prompting the user to enter or confirm location information, such as a city, the name of the merchant establishment, a specific location of a merchant establishment, or a combination thereof.

In some embodiments, the merchant establishment may have micro-location technology distributed within particular sites in the establishment or affixed to or associated with specific sites, such as tables in a restaurant. The micro-location technology may rely on near-field communications technologies such as Bluetooth™ and/or may use systems such as, but not limited to, the iBeacon™ proximity sensing protocols and technologies. From a micro-location transmitter close or closest to the user device 110, the user device 110 may receive an identifier for the merchant establishment and/or a location identifier of the micro-location transmitter. The merchant establishment identifier and location identifiers may correspond to the identifiers and information provided by the merchant establishment when it created or updated its retail account. Alternatively, the merchant establishment identifier and/or the location identifiers provided by the user device 110 from a micro-location transmitter may be added by server 120 to the retail account associated with the establishment as the server tracks and learns the identifiers when processing multiple bills for that establishment.

The electronic capture of the bill and any merchant establishment or location information or identifiers may be transmitted to the server 120 by the user device 110 (step 340) through the communications network 130. The network 130 may include an unrestricted or free public WLAN, such as a WLAN provided by the merchant establishment itself. Since the electronic transaction software application does not require a user to send sensitive financial information, such as a credit card number, to initiate payment of the bill, the use of a less secure wireless network may be acceptable to the user.

Once the bill and location information have been processed by the server 120, the user device 110 receives and displays (step 350) a request to confirm the payment of the bill as described above. The user may modify the details of the transaction and send confirmation to complete the transaction (step 360). In some embodiments, the user device 110 also may receive a confirmation that the transaction to pay the confirmed amount of the bill has been completed.

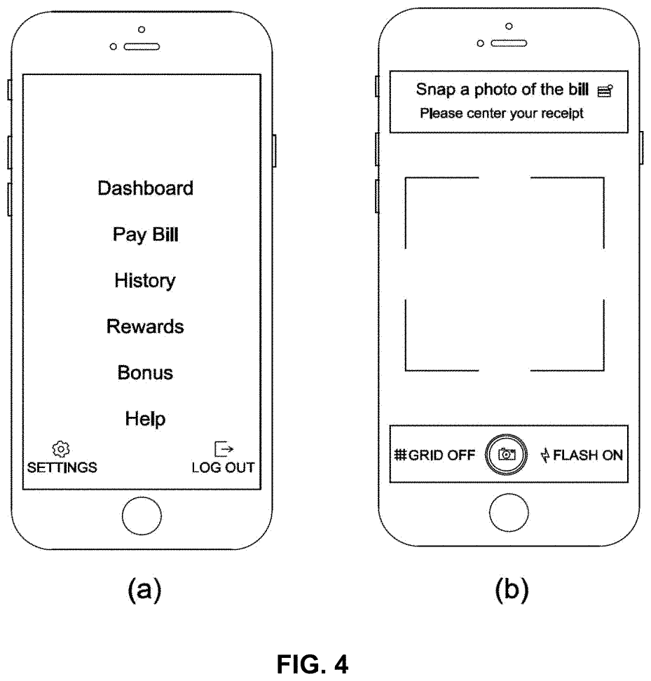

FIGS. 4(a)-(d) illustrate sample user displays or interfaces which may be shown on the device 110 during operation of the electronic transaction software application described herein. FIG. 4(a) illustrates a sample screen display or “dashboard” which appears after the electronic transaction software application is launched. In response to a user selecting the option to “pay bill”, the interface of FIG. 4(b) may be provided to enable the user to capture an image of the bill. Instructions and/or positive or negative feedback may be provided to the user via this interface to ensure that the user has centered the bill and that an acceptable image has been or will be captured.

FIG. 4(c) illustrates a sample interface presented to a user after the user device 110 has received the request from the server 120 to confirm the payment to the merchant establishment. This interface may include the name and other identifying information of the merchant establishment, including a mapped location. In some embodiments, the user may select the information such as the merchant establishment or the displayed location in order to confirm or correct the information. The interface shown in FIG. 4(c) may also display the amount of the bill and options for the user to confirm payment of the entire bill, or only a portion of the bill, and to add a tip. In response to the user entering or selecting a command to “pay bill”, the user device 110 sends an instruction or message to the server 120 to pay the bill for the confirmed amount. FIG. 4(d) illustrates a sample display presented to a user after the electronic payment has been executed and the user device 110 has received confirmation from the server 120. The display may include a confirmation number for the transaction and other information or updates, such as reward program points earned by the user in association with the transaction.

Additional methods for payment of a bill or invoices associated with a merchant or merchant establishment may be provided using the systems, devices and methods described herein. In some embodiments, the server 120 is configured to interact with the POS system 140 and/or staff devices 150 in order to obtain the billing information associated with a user device 110, by associating one or more POS systems 140 and/or staff devices 150 with the retail account as described above. The server 120 associates the POS systems 140 and/or the staff devices 150 with the user account by executing a software application as described above. The billing information is associated with the user device 110 and customer by determining location information for the user device 110 within a merchant establishment and by obtaining billing information stored in the POS system 140 and/or staff device 150 which is related to the location. Thus, a customer is not required to capture an image of the bill with the user device 110 or send this information to the server 120.

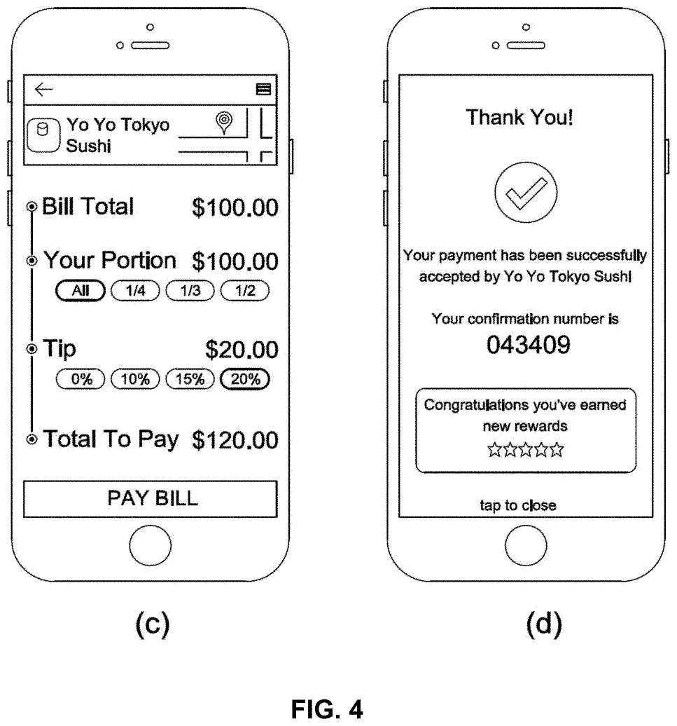

Specifically, in some embodiments, location information for a user device 110 in a merchant establishment is determined by the use of near-field communications or micro-location technologies as mentioned above. The system in FIG. 5 is the same as that in FIG. 1, except that the system 500 may include one or more short distance transmitters (SDT) 160, often referred to as beacons. The SDT 160 may be placed within the merchant establishment for transmitting beacon signals. The SDT 160 may comprise Bluetooth™ low energy devices or devices transmitting signals according to Apple™ iBeacon™, or Google™ Eddystone™, or other protocols. Each SDT 160 is configured to transmit a signal containing information such as an identifier of the SDT 160 or a Universal Resource Locator (URL) which is associated with the specific SDT 160. Depending on types of the SDT 160, beacon signals typically may be received within 4 to 90 m. In some embodiments, the beacon signal also includes an identifier associated with the merchant establishment. The user device 110 receives the one or more beacon signals from one or more SDT 160 and executes the user electronic transaction software application to determine location information for the user device 110 based on the strength and/or frequency of each beacon signal, and/or content of each beacon signal, such as the identifier of the SDT 160. Based on the received beacon signals alone, or in combination with other information gathered by or available to the user device 110, various triangulation or trilateration processes may be executed by the user device 110 or the server 120 to determine an absolute or relative position of the user device 110.

As described above, the locations of the SDTs 160 within a merchant establishment are known to the server 120 and/or the user device 110. In an example, by combining the beacon signals generated by multiple SDTs 160 with the signal strength and/or distance estimate from the user's user device 110 to each beacon signal, a mathematical triangulation or trilateration of the location of the user and the user device 110 can be determined.

In some embodiments, the user device 110 determines its location within a merchant establishment and transmits this information to the server 120. In other embodiments, the user device 110 transmits information regarding the received beacon signals to the server 120 and the server 120 is configured to determine the location of the user device 110 within a merchant establishment using the triangulation or trilateration processes described above.

For example, in one embodiment, multiple SDTs 160 are mounted at various points within a merchant establishment such as a restaurant. Each SDT 160 may be a standalone device or it may be part of another device such as a POS device. SDTs 160 may be placed, for example, on the walls of the establishment and/or on each table and seat, and/or as part of another fixture or device so as to blend in with the restaurant environment. The SDT 160 locations, transmission powers, and other characteristics are configured so that each table and seat location can be uniquely determined by a user device 110 located in or near each seat location.

In some examples, each SDT 160 is placed at a predetermined location within the merchant establishment, such as on the bottom surface of each table and seat. The predetermined location of each SDT 160 in the merchant establishment is registered with the electronic transaction service provider, such as the server 120. The user device 110 receives at least one beacon signals from the SDTs 160. Typically, the beacon signal with the strongest strength correspond to the SDT 160 placed on the seat on which the user sits. Therefore, the SDT 160 with the strongest signal strength received by the user device 110 indicates the location of the user device 110 and therefore the location of the user. As such, by identifying identifier of the SDT 160 with the strongest beacon signal among the received beacon signals, the user device 110 then has the same location as the SDT 160, as registered in the server 120. Accordingly, by knowing the specific location of a SDT 160 within a merchant establishment, the server 120 knows the location of the user device 110, and the location of the user associated with the user device 110, such as the seat number and the table number.

In some embodiments, the beacon signals of SDT 160 are used along with additional information gathered by sensors or components within the user device 110 to determine the location information. This additional information may include, for example, GPS coordinates of the user device 110, or scans of elements unique to a table or seat such as QR codes or numbers, words or items on a table. The mapping or grid of locations generated by the use of beacons is correlated with the table and seat number assignments in the restaurant's POS system and this information may be stored by the server 120. The mapping or grid locations may be updated in the server 120 from time to time as the restaurant table configuration, seat positions, and/or numbering scheme changes. It will be appreciated that other establishments may be mapped in this manner including but not limited to locations or seats in a stadium, arena, theatre, hair salon or other merchant establishment.

While a customer is seated at a table in a restaurant, the customer's user device 110 may receive one or more beacon signals from one or more SDTs 160. In one embodiment, based on the received beacon signals, the user device 110 determines its current location information, for example, by a triangulation or trilateration process, and transmits this location information to the server 120. The location information may be determined at any time, such as when customer first arrives at the restaurant, at the end of a meal service and/or when the customer uses the software application to proceed with bill payment. In some embodiments, the location information may comprise information regarding the received beacon signals and/or identifiers. This information is transmitted to the server 120 and the server 120 processes and correlates the location information with the known mapping or grid location information for the restaurant location in order to determine a current table and seat number corresponding to the customer and user device 110. In some embodiments, the user device 110 receives information regarding the mapping or grid of locations for the restaurant location from the server 120 and the user device 110 determines a specific table and seat number in the restaurant or other predetermined grid location. In that case, the location information transmitted to the server 120 may indicate a specific location or position in the merchant establishment and may not require further processing by the server 120.

In some embodiments, the restaurant identification and, if applicable, a specific restaurant location, are also determined by the user device 110 and/or by the server 120 based on the received beacon signals. In other embodiments, the identification of the restaurant and restaurant location may be determined by the user device 110 and/or the server 120 through other means such as by using GPS coordinates of the user device 110, or by a customer selecting a specific restaurant location within the software application.

In one embodiment, based on the retail store or restaurant identification and location information of the user device 110, the server 120 communicates with the POS system 140 of the restaurant location to request the billing information associated with the table and seat number for the customer and user device 110. The information of the goods and services provided to a user at a specific seat of a table is stored in the POS system 140 or staff device 150. Therefore, the POS system 140 and the staff device 150 has the billing information associated with the table and seat number for the customer and user device 110. In other embodiments, the POS system 140 may generate and send the billing information to the server 120, such as in response to a staff person selecting a command to process a specific bill or table and seat number for payment. The billing information may include, as described above, a bill number; the merchant establishment name, account and/or location identifier; an amount owed to the merchant establishment; the name and/or number of a staff person such as a waiter or server associated with the bill or table; a till number; a product or service identifier; or combinations thereof. In some embodiments, these actions are achieved by modifying or configuring the POS system 140 with the electronic transaction software application described herein in order for the POS system 140 to interact and/or communicate with the server 120. In other embodiments, each staff device 150 receives a software application which is executed to support these actions.

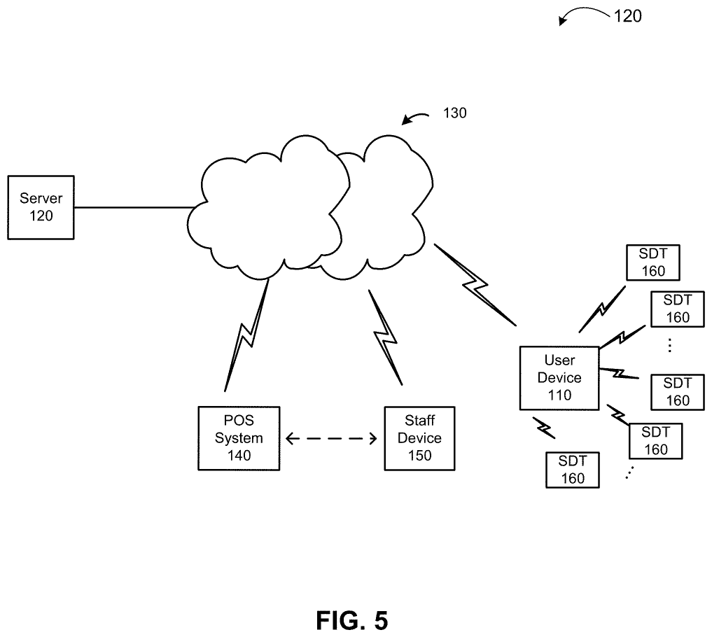

FIG. 6 illustrates another embodiment of a method 600 provided by the server 120 of an electronic transaction service provider. The server 120 receives location information of the user device 110 (step 620). The location information may include beacon signals received by the user device 110, and the server 120 further determines the specific location of the user device 110 and thus the user within a merchant establishment, such as a seat number of a table within the merchant establishment. In some examples, the location information includes the specific location of the user device 110 within a merchant establishment, such as a seat number of a table within the merchant establishment restaurant. The location information may also include at least an identifier of the merchant establishment, and/or the GPS coordinates of the merchant establishment.

Based on the location information from the user device 110, the server 120 then determines the identity of the specific merchant establishment, and the bill associated with the user device 110 at a specific seat of the merchant establishment (step 630). In an example, the billing information related to the bill may be checked and confirmed by the server 120 to ensure the bill is associated with a valid retail account created in the server 120. The server 120 creates and sends a request to the user device 110 to confirm payment of the bill (step 640). The request may include an amount to be paid out. This may occur in response to a request by the user device 110 to pay a bill. In other embodiments, the request for the customer to confirm payment of the bill may be transmitted automatically by the server 120 based on the existence of an open or unpaid bill in the POS system 140 for the location associated with the user device 110. Once confirmation of a payment amount is received from the user device 110, the server 120 creates an electronic payment transaction (step 650) to deduct the confirmed payment amount from an account associated with the user and to provide a payment to an account associated with the merchant for the confirmed amount. Optionally, sends notification of a paid bill (step 660) to the user device 110, POS system 140 and/or staff device 150, for example, by sending an email message to the associated staff person.

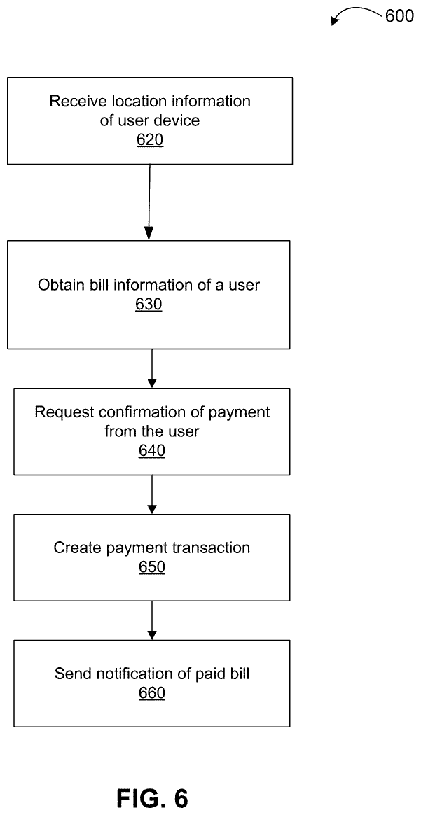

FIG. 7 illustrates another embodiment of a method 700 provided by user device 110. The user device 110 in this embodiment may be configured to determine a more specific location of the device 110 (step 710), and send the location information to the server 120 (step 720). In some examples, the user device 110 may simply send the received beacon signals, which contain location information of the user device 110, to the server 120, and the server 120 then determines the specific location of the user device 110 using, for example a triangulation or trilateration process or based on the strength of the received beacons signals, according to the predetermined locations of each SDT 160 within a merchant establishment. Other information also may be transmitted to the server 120, as described above, such as a user's selection of a restaurant location or GPS coordinates for the user device 110. In this embodiment, however, an image capture or electronic representation of the bill is not created or sent by the user device 110. The user device 110 receives a request to confirm a payment (step 730) and in response to a user confirming the payment, sends a confirmation to the server 120 in order to complete the transaction (step 740). As described above, the customer may be presented with other options to add a tip, pay only a portion of a bill, collect or use rewards and/or coupons as part of this transaction.

In a further embodiment, the actions of determining location information for the user device 110 at a merchant establishment consist of determining or identifying a POS device, such as staff device 150 or other component, payment terminal, cash register, or the like, (not shown) in the POS system 140 which is nearest to the user device 110. For example, a customer may not be seated or associated with a table and seat number at a restaurant. Instead, if ordering and/or paying for a food or another purchase at a counter, the customer may launch the electronic transaction software application. The user device 110 may receive one or more signals from one or more beacon devices as described above. Based on the received signals the user device 110 determines the nearest POS device at the current establishment.

As described above, the identification of the merchant establishment and, if applicable, a specific retail location, are determined by the user device 110 and/or by the server 120 based on the received beacon signals alone or in combination with other means such as by using GPS coordinates of the user device 110, or by a customer selecting a specific restaurant or retail location within the software application. This information may be used by the user device 110 and/or by the server 120, along with the identification of the nearest POS device, in order to determine an outstanding bill associated with the user device 110. In some embodiments, the POS device may transmit the billing information for an open or selected transaction to the server 120. In other embodiments, based on the identified merchant establishment and POS device, the server 120 may request the billing information from the POS device and/or from the POS system 140, for one or more open or unpaid transactions of a user device 110. In a further embodiment, the billing information may be transmitted by the POS device directly to the user device 110 using Bluetooth™ or similar short-distance communications technologies. In this embodiment, the user device 110 is configured to send the billing information directly to the server 120. The billing information may be checked and confirmed by the server 120 to ensure it is associated with a valid retail account. As described above, the server 120 then sends a request to the user device 110 to confirm payment of the bill, and payment may be approved and confirmed.

In other example embodiments, a customer's position is not necessarily fixed or linked to a table and/or seat but can be defined by a different relationship to an identifier in the POS system 140. For example, a beacon device in a golf cart may transmit a signal which is received by the user device 110. Orders associated with the specific golf cart number in the POS system of the golf course thus may be linked to the user device 110 and customer for payment. In these embodiments, the GPS coordinates of the user device 110 also may be used by the user device 110 and/or by the server 120 to determine and/or verify the location of the user device 110 at the establishment associated with the beacon signals.

Reference is next made to FIG. 8 which illustrates a wireless communication device 800 in accordance with the present disclosure. The wireless communication device 800 includes a processing system comprising a processor 804 (such as a microprocessor or central processing unit (CPU)) which controls the overall operation of the wireless communication device 800. The processor 804 is coupled to a plurality of components via a communication bus (not shown) which provides a communication path between the components and the processor 804. The processor 804 is coupled to RAM 808, ROM 810, and persistent memory 812 such as flash memory and a communication subsystem 830.

The communication subsystem 830 includes one or more wireless transceivers for exchanging radio frequency signals with wireless networks. The communication subsystem 830 may also include a wireline transceiver for wireline communications with wired networks. The wireless transceivers may include one or a combination of Bluetooth transceiver or other short-range wireless transceiver, a Wi-Fi or other WLAN transceiver for communicating with a WLAN via a WLAN AP, or a WWAN transceiver such as a cellular transceiver for communicating with a radio access network. The cellular transceiver may communicate with any one of a plurality of fixed transceiver base stations of the cellular network within its geographic coverage area.

The wireless communication device 800 also comprises a microphone 832, a speaker 834, a camera 836, a touchscreen 838, a clock (not shown) and a satellite receiver 840 for receiving satellite signals from a satellite network that includes a plurality of satellites which are part of a global or regional satellite navigation system, each coupled to the processor 804. The touchscreen 838 is typically a capacitive touchscreen. The wireless communication device 800 may also comprise a plurality of sensors 844 coupled to the processor 804. The sensors 844 may comprise a biometric sensor such as face scanner or fingerprint scanner, a motion sensor such as an accelerometer, an IR sensor, a proximity sensor, an orientation sensor, electronic compass or altimeter, among possible embodiments. The wireless communication device 800 may also comprise one or more other input devices 842 such as buttons, switches, dials, a keyboard or keypad, or navigation tool, depending on the type of the wireless communication device 800.

Operating system software 880 executable by the processor 804 is stored in the persistent memory 812 but may be stored in other types of memory devices, such as ROM 808 or similar storage element. The operating system software 880 provides a VUI for user interaction with the wireless communication device 800 in the form of touch inputs detected via the touchscreen 838 and/or other input devices 842. A number of application programs 888 executable by the processing system, including the processor 804 are also stored in the persistent memory 812. The application programs 888 include the payment application 860. The payment application 860 may be part of a shopping application.

The memory 812 stores a variety of data 872, including sensor data acquired by the sensors 844, location data about the location of the wireless communication device 800, input data acquired by the touchscreen 838 and/or other input devices 842, user data 874 including data about the payment application 860, user preferences, settings and possibly biometric data about the user for authentication and/or identification, a download cache including data downloaded via the wireless transceivers, and saved files. System software, software modules, specific device applications, or parts thereof, may be temporarily loaded into RAM 808. Communication signals received by the wireless communication device 800 may also be stored in RAM 808. Although specific functions are described for various types of memory, this is merely one embodiment, and a different assignment of functions to types of memory may be used in other embodiments.

The wireless communication device 800 may also comprise a battery (not shown) as a power source, such as one or more rechargeable batteries that may be charged, for example, through charging circuitry coupled to a battery interface such as the serial data port. The battery provides electrical power to at least some of the components of the wireless communication device 800, and the battery interface (not shown) provides a mechanical and electrical connection for the battery.

FIG. 9 shows in schematic block diagram form a server 900 in accordance with the present disclosure. The server 900 may be used to implement the server 120 or other servers described herein. The server 900 includes a controller comprising at least one processor 902 (such as a microprocessor) which controls the overall operation of the server 900. The processor 902 is coupled to a plurality of components via a communication bus (not shown) which provides a communication path between the components and the processor 902.

The processor 902 is coupled to one or more memories 904 which may include RAM, ROM, and persistent memory such as flash memory, and a communication subsystem 906 for exchanging data signals with user devices 110 and staff devices 150, and possibly a POS terminal 140 and/or computing terminal located at a merchant establishment of a wireless payment system of the present disclosure. The communication subsystem 906 may include a wireless transceiver for wireless communications and a wireline transceiver for wireline communications with wired networks such as a LAN. The wireless transceivers may include one or a combination of Bluetooth transceiver or other short-range wireless transceiver, a Wi-Fi or other WLAN transceiver for communicating with a WLAN via a WLAN AP, or a cellular transceiver for communicating with a radio access network. The server 900 may optionally include a display 908 and one or more input devices 910 such as a keyboard and mouse.

The server 900 is located remote from the merchant establishment and user 101 and may be implemented as multiple servers that, in some examples, provide a network-accessible computing platform implemented as a computing infrastructure of processors, storage, software, data access, and so forth that is maintained and accessible by the user devices 110, staff devices 150 and possibly a POS terminal 140 and/or computer terminal at the merchant establishment via the communication network 130. The computational functions performed by the server 900 may be referred to as “on-demand computing,” “software as a service (SaaS),” “platform computing,” “network-accessible platform,” “cloud services,” “data centers,” and so forth.

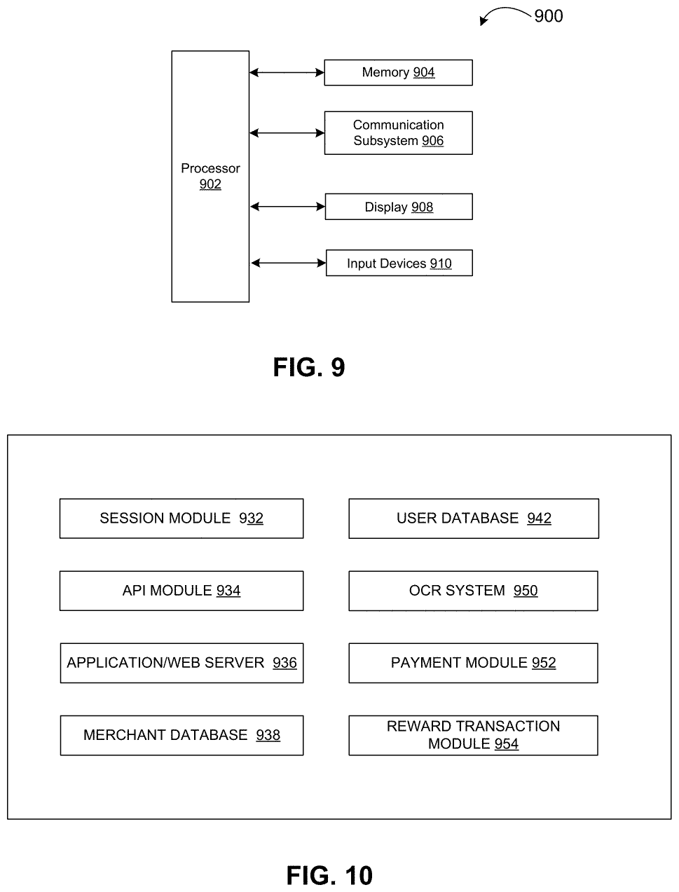

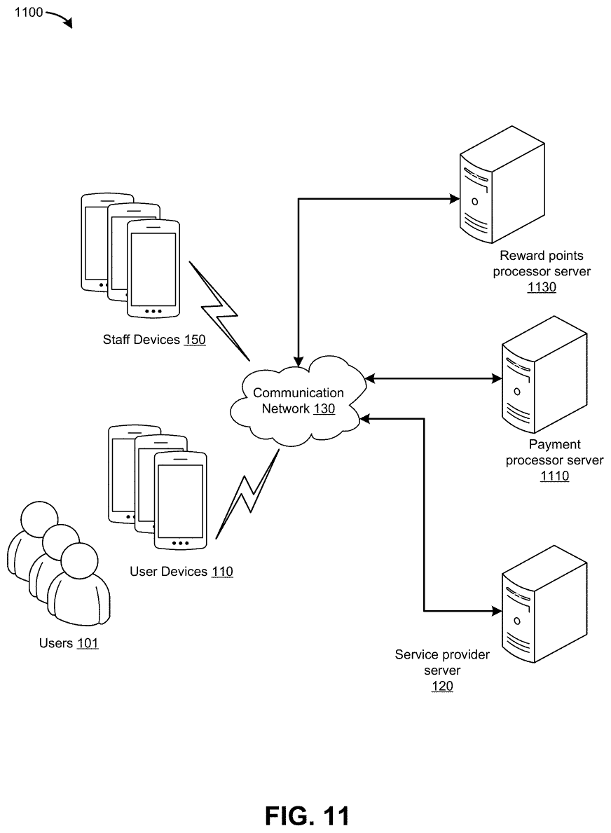

FIG. 10 is a block diagram of a subset of the functional modules of the server 120 in accordance with the present disclosure. The functional modules comprise a session module 932, an application programing interface (API) module 934, an application or Web server module 936, a merchant database 938, a user database 942, OCR system 950, a payment module 952, and a reward transaction module 954. Other databases may also be used be provided, for example, for handling sales taxes, operational log messages, or other data such as loyalty (or rewards) data, promotional data, or advertising data. The server 210 may define sales tax data and other transaction data and information for completing and recording payments. The payment module 952 generates payment instructions for a payment processor server 1110 (FIG. 11), to which the payment instructions are sent via the communications network 130. The payment processor server 1110 comprises one or more servers and may be operated by a third party. The payment module may be configured to accept payments with credit card, e-transfer (e.g., Interac™) or payment services such as Apple Pay™, Google Pay™, Paypal™ and AliPay™. The reward transaction module 954 also generates reward transaction instructions for a reward points processor server 1130 (FIG. 11), to which the reward transaction instructions are sent via the communications network 130. Although separate modules and databases are described, the modules and/or databases may be combined in other embodiments.

The merchant database 938 and user database 942 store account and payment information associated with merchants and users respectively. The account and payment information is stored in corresponding records in the merchant database 938 and user database 942. Each account in the databases 938, 942 comprises account information and configuration data such as an account holder name, username or user ID and password or personal identifier plurality (PIN), for logging into and using the payment application 860, address, and payment information for which payments are authorized. The payment information may comprise data and/or information required to make and/or receive payments with credit card, electronic funds transfer (e.g., Interac™) or payment services such as Apple Pay™, Google Pay™, Paypal™ and AliPay™.

The session module 932 manages sessions with user devices 110 via the payment application 860. Each registered user has a user account stored in a user registry stored in the user database 942. Each user has unique user credentials stored in the user database 842 as noted above. The session module 932 receives user login information and attempts to authenticate the user at the start of a session. When a user is authenticated, the session module 932 may receive a session token and send the session token to a corresponding wireless communication device 800. User data for each session is stored by the server 120, for example, in the session database (not shown). The API module 934 may be used to extract, transform, and combine information such as order information from the payment application 860 or external other sources.

FIG. 11 is a schematic block diagram of a wireless payment system 1100 in accordance with another example embodiment of the present disclosure. The wireless payment system 1100 includes a plurality of user devices 110 operated by users 101, a service provider server 120, a payment processor (also known as a transaction processor) server 1110, and a reward points processor (also known as a transaction processor) server 1130. The wireless payment system 1100 may also include a plurality of staff devices 150 operated by staff members located in a merchant establishment. Although not shown, the wireless payment system 1100 may also comprise a POS system 140 which may be an mPOS (mobile POS) system or terminal. Different components of the wireless payment system 1100 may communicate with each other via different channels of the communication network 130, in some examples.

The service provider server 120 communicates with the payment processor server 1110 via the communication network 130. Alternatively, the service provider server 120 may comprise the payment processor server 1110. The payment processor server 1110 comprises one or more servers and may be operated by a third-party unrelated to the merchant or service provider operating the service provider server 120. Examples of payment processor server include those provided by Lightspeed Payments™ provided by Lightspeed POS Inc., Global Payments™ by Global Payments Inc., or Moneris™ and Vantiv™ provided by Vantiv, Inc. Other suitable payment processors may be provided by financial institutions, financial service providers, and the like. The payment processor server 1110 processes financial transactions relating to sales/payments of the merchant.

The service provider server 120 also communicates with a reward points processor server 1130 via the communication network 130. Alternatively, the service provider server 120 may comprise the reward points processor server 1130. The payment may be fully or partially performed using reward points (or loyalty points) of the operator of the service provider server 120. The reward points processor server 1130 manages reward points associated with user accounts of the service provider server 120, which are stored in the user database 942. Each reward point has a monetary or dollar value which may vary. The reward points may be allocated as coins of a digital currency of the mobile commerce platform provided by the wireless payment systems of the present disclosure.

During payment while completing a transaction, a selected amount of reward points is deducted from a reward balance, which may be stored in the user database 942 or a separate database on the server 120, and a dollar amount corresponding to the selected amount of reward points is deducted from the payment amount to generate a balance due. The reward point transaction is typically performed by the reward points processor server 1130 before the financial transaction for the balance due is performed by the payment processor server 1110.

Reward points are earned based on the value of the transaction performed by the payment processor server 1110, i.e. based on the value of the balance due when the payment of the payment amount is performed partially performed using reward points. A reward point transaction is typically performed by the reward points processor server 1130 after the financial transaction is performed by the payment processor server 1110. The rate at which reward points are accumulated may be based on a progressive levels (or tiers) based on a spending threshold, for example an annual spending threshold that resets back to level 1 and a spending amount of zero ($0) on an anniversary of the account creation or date of first use of the payment application 860. The current level or rate of accumulated depends on the spend total for the current year and possibly also a type of purchase (e.g., restaurant, parking, etc.). The spend for the current year, reward level, and reward point balance are stored in the user database 942 or a separate database on the server 120 along with the accumulation rates for the various levels and optionally purchase types. The accumulation rate is different from the monetary or dollar value of each reward point acquired. An example of pregressive reward point levels/tiers is provided below in Table 1.

TABLE 1
Progressive Reward Point Levels/Tiers

| | | Earning Percentage | | | | |
|---|---|---|---|---|---|---|
| | Spending | Purchase Type 1 | Purchase Type 2 | Purchase Type 3 | Purchase Type 4 | Purchase Type 5 |
| Level | Threshold | (Dropshipping orders) | (Gift Card) | (Restaurants) | (Payments) | (Parking) |
| 1 | $0-$199.99 | 1% | 0.2% | 0.2% | 0.2% | 1% |
| 2 | $200 | 1.5% | 0.25% | 0.25% | 0.25% | |
| 3 | $500 | 2% | 0.3% | 0.3% | 0.3% | |
| 4 | $1000 | 2.5% | 0.4% | 0.4% | 0.4% | |
| 5 | $1500 | 3% | 0.5% | 0.5% | 0.5% | |

Similar to reward points, the payment may be fully or partially performed using coupons or promotions, which can be received electronically via an in-application message which is automatically received and processed by the payment application 860, input via scanning a QR code or other bar code associated with the coupons or promotions, or input a code associated with the coupons or promotions via a keypad of the wireless communication devices 202.

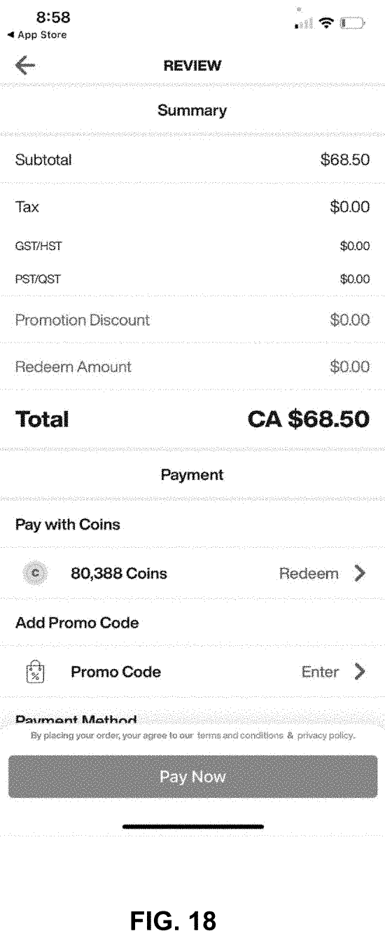

FIG. 18 is an example payment screen of a visual user interface of a user device 110 in accordance with an example embodiment of the present disclosure. The payment screen allows rewards and promotions to be applied the subtotal before payment.

The wireless payment systems of the present disclosure provides a mobile commerce platform with perks on mobile payments, ecommerce, and digital gift cards. The mobile commerce platform provides user experiences that seek to make shopping and dining experiences more engaging, convenient, and rewarding. The mobile commerce platform may be used to order and pay at restaurants, for online shopping and to buy digital gift cards from a variety of merchants and brands. The mobile commerce platform features Shopify™ integration, contactless payments using Apple Pay™, Google Pay™, BitPay™ and Alipay™, its own digital currency, a gamified loyalty (rewards) program, pre-order and pick up, and in-store payments with a QR code. The mobile commerce platform maybe used to drive growth through a unique community-driven digital franchise business that is available to entrepreneurs at an attractive start-up price.

The above-described wireless payment systems 100 and 1100 are provided for the purpose of illustration only. The above-described wireless payment systems 100 and 1100 includes example possible communication network configurations of a multitude of possible configurations. Suitable variations of the wireless payment systems 100 and 1100 will be understood to a person of skill in the art and are intended to fall within the scope of the present disclosure. In some embodiments, the wireless payment systems 100 and 1100 includes multiple components distributed among a plurality of computing devices (e.g., servers, computer terminals, etc.). One or more components may be in the form of machine-executable instructions embodied in a machine-readable medium.

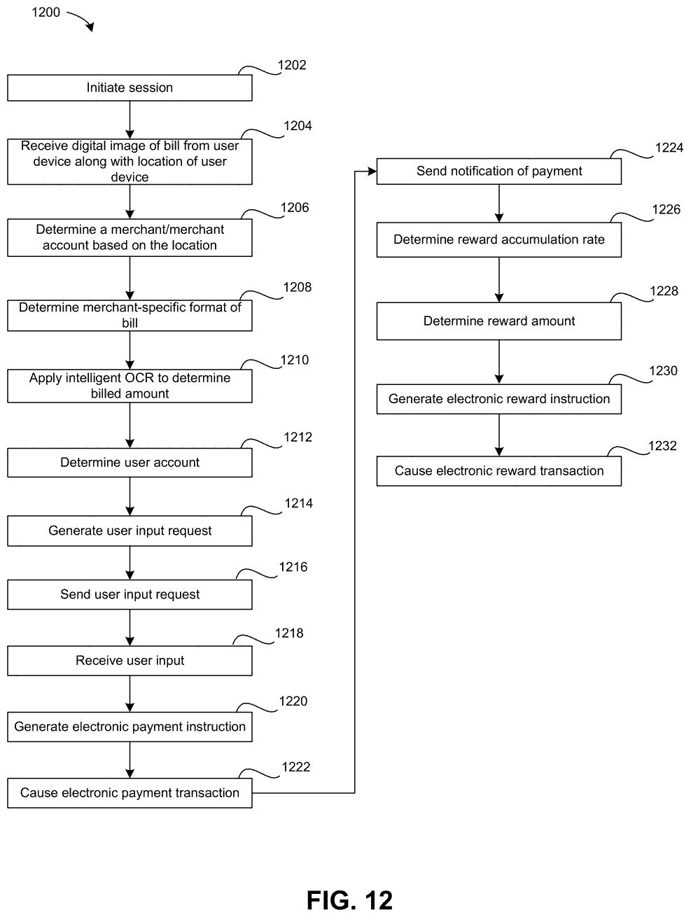

Referring now to FIG. 12, a computer-implemented method 1200 of electronic bill payment in accordance with another embodiment of the present disclosure will be described. At least parts of the method 1200 are carried out by software executed by a processor 902 of the server 120.

At step 1202, a session is initiated on a user device 110 of a user 101 with the server 120. The session may be initiated in response to input such as a sign-in or log-in to the payment application 860. For example, the sign-in or log-in may occur based on input to launch the payment application 860 and optionally enter user credentials to authenticate the user 101. The payment application 860 may be a native smartphone application (e.g., for iOS or Android operating systems) or a Web application. If the user does not have the payment application 860 on his or her user device 110, the payment application 860 can be downloaded from an application store associated with the user device 110, a website or other suitable means, or when the application is a Web application, accessed via a Web browser. For example, the Web application may be accessed by scanning a store QR code for the payment application 860 presented on a bill, parking ticket, signage, NFC tag or the like. With customer approval, the payment application 860 may provide geolocation services that track the user's location over time, learning about merchant establishments that user visits. The payment application 860 is a lightweight application that communications with back-end services provided by the (e.g., cloud) server 120 that provides various services described herein such as a payment and reward processing, among other functions. A user identifier (ID) associated with a user of the user device 110 is received by the server 120 as part of the session initiation.

At step 1204, the server 120 receives from the user device 110 a digital image of a bill captured by a digital camera 836 of the user device 110 and a location of the user device 110 at a time at which the digital image was captured. The location may comprise a global positioning system (GPS) location of the wireless communication device, a location of the wireless communication device in cellular communications network, a micro-location of the wireless communication device in a retail location associated with the retailer, an identifier associated with the retail location, a user selected location, or a combination of two or more thereof.

At step 1206, the server 120 determines a merchant based on the location of the user device 110 at the time at which the digital image was captured. The server 120 keeps location information for each merchant in the merchant database 938 and determines the merchant by comparing location information for the user device 110 for the stored location for the merchants in the merchant database 938 identifying a match. A match may be determined when the location of the user device 110 at the time at which the digital image was captured is within a threshold distance or within a geofence or geographical boundary of the merchant establishment.

At step 1208, the server 120 determines a merchant-specific bill format of the bill based for the merchant. The server 120 keep a merchant-specific bill format for each merchant in the merchant database 938 and determines the merchant-specific bill format by retrieving the merchant-specific bill format for the merchant based on a merchant ID. The merchant-specific bill format defines, among other possibilities, the location of important fields for used when performing intelligent OCR. The merchant-specific bill format of the bill may be based on both the merchant and the location of the wireless communication device at the time at which the digital image was captured in some embodiments. This allows the bill format to vary based on the location of the merchant establishment.

At step 1210, the server 120 determines a billed amount by analyzing the digital image using intelligent OCR based on the merchant-specific bill format of the bill. The determining may comprise: converting, by applying OCR, the digital image into a plurality of cells, each cell comprising text; and selecting a value of a cell in the plurality of cells as the billed amount based on a designated cell in accordance with the merchant-specific bill format. The cells generated by applying OCR may be arranged by rows and columns in some embodiments. In such embodiments, the designated cell is defined by row and column.

At step 1212, the server 120 determines a user account associated with the user device 110 based on the user ID.

At step 1214, the server 120 generates a request for user input confirming payment of the bill based on the billed amount. The request causes a VUI screen to be displayed on a display (e.g., touchscreen 836) of the user device 110. The VUI includes an element for receiving user input for confirming payment of the bill. The VUI may comprise an element for specifying the payment amount from a plurality of payment options. The plurality of payment options may include a portion of a billed amount and an amount of a tip to be added to the billed amount based on the portion of the billed amount to be paid.

The merchant may have merchant or merchant establishment rules for the merchant. In such embodiments, the method 1200 comprises determining any merchant or merchant establishment rules for the merchant and applying any merchant or merchant establishment rules. In some embodiments, the VUI only comprises the element for specifying the payment amount from a plurality of payment options in response to a matching rule. The rules may be based on the merchant and the location of a merchant establishment associated with bill (i.e., the location of the user device 110 at the time at which the digital image was captured).

At step 1216, the server 120 sends the request to the user device 110, which causes the VUI to be displayed on the user device 110.

At step 1218, the server 120 receive user input confirming payment of the bill from the user device 110. The user input indicating a payment amount.

At step 1220, the server 120 generates an electronic payment instruction in response to receiving user input confirming payment of the bill from the user device 110. The electronic payment instruction is based on payment information associated with the user account, payment information associated with a merchant account of the merchant and the payment amount. As noted above, the payment information associated with the user account and the merchant are maintained by the server the merchant maintained by the server 120.

At step 1222, the server 120 causes the electronic payment transaction to be performed. In some embodiments, causing the electronic payment transaction to be performed comprises executing the electronic payment transaction. In other embodiments, causing the electronic payment transaction to be performed comprises sending the electronic payment instruction to a payment processor server 1110 for execution.

At step 1224, the server 120 may send a notification to the merchant confirming payment of the bill subsequent to completion of the electronic payment transaction. The notification to the merchant may comprise sending an electronic message to a staff device 150 of a staff person associated with the bill. The staff person associated with the bill is determined by performing intelligent OCR based on the merchant-specific bill format of the bill.

At step 1226, the server 120, subsequent to completion of the electronic payment transaction, determines a reward accumulation rate for the user account based on the user ID.

At step 1228, the server 120 determines a reward amount based on the payment amount and the reward accumulation rate. The reward accumulation rate may be based a progression level and optionally a purchase type.

At step 1230, the server 120 generates a reward transaction instruction based on the user ID and the reward amount.

At step 1232, the server 120 causes the reward transaction to be performed. In some embodiments, causing the reward transaction to be performed comprises executing the reward transaction. In other embodiments, causing the reward transaction to be performed comprises sending the reward transaction instruction to a reward points processor server 1130 for execution.

The method 1200 is believed to provide a relatively simple yet effective approach for determining billing information and accepting payment for many types of merchants when the described intelligent OCR algorithm is used in combination with the other data sources and steps in the described method 1200 and a location of a merchant is provided by location information acquired by the user device 110. The described method 1200 requires only limited knowledge about the merchant-specific bill format and does not require costly or and complex training. This allows easier and faster adoption, facilitating the onboarding of merchants, while also allowing merchants to change their bill format at any time without impact to existing process.

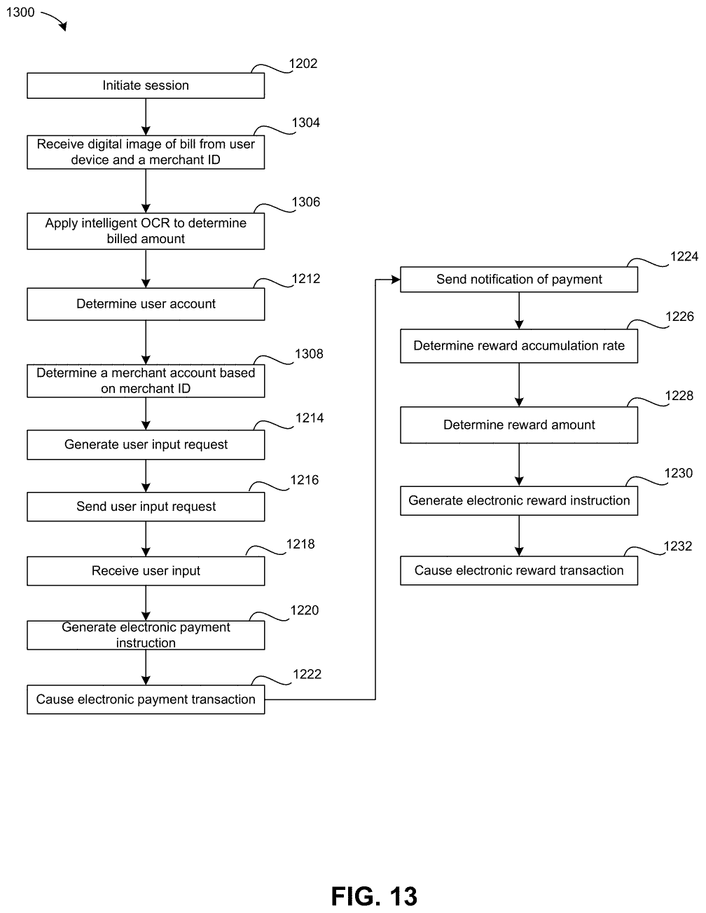

Referring now to FIG. 13, a computer-implemented method 1300 of electronic bill payment in accordance with another embodiment of the present disclosure will be described. At least parts of the method 1300 are carried out by software executed by a processor 902 of the server 120.

At step 1202, a session is initiated on a user device 110 of a user 101 with the server 120 as described above in connection with FIG. 12.

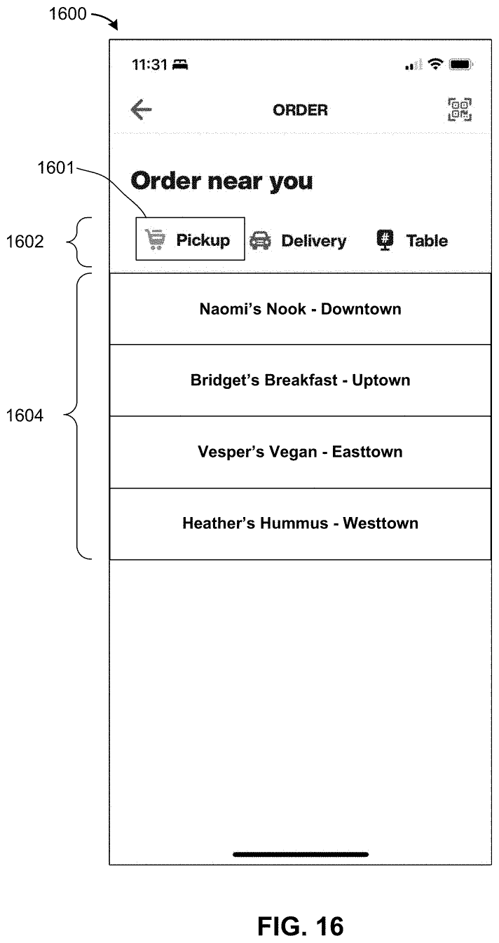

At step 1304, the server 120 receives from the user device 110 a digital image of a bill captured by a digital camera 836 of the user device 110 and a merchant ID. The merchant ID may be provided by a selection of a restaurant 1604 within a restaurant VUI screen of the payment application 860, an example of which is described below in connection with FIG. 16. The location information about the user device 110 at the time at which the image was captured is not used to determine the merchant or merchant ID.

At step 1306, the server 120 determines a billed amount by analyzing the digital image using intelligent OCR by identifying a set of all numbers present in the bill. Next, a subset of numbers is generated by removing numbers above a threshold from the set of all number present in the bill. Lastly, the highest number from the subset of numbers as the billed amount is selected. In some embodiments, the threshold is based on a merchant type. In such embodiments, the server 120 determines a merchant type based on the merchant ID using the merchant information stored in the merchant database 938. Examples of merchant types include restaurants, retail and parking. As an example, the threshold applied when the merchant is a restaurant or retail may be 1,000 whereas the threshold applied when the merchant is a parking company may be 100. The threshold may be configurable by the merchant.

At step 1212, the server 120 determines a user account associated with the user device 110 based on the user ID. At step 1308, the server 120 determines a merchant account associated with the merchant based on the merchant ID. Steps 1214 to 1232 are then performed as described above in connection with FIG. 12.

The inventors have found that the method 1300 provides a relatively simple yet effective approach for determining billing information and accepting payment for many types of merchants when the described intelligent OCR algorithm is used in combination with the other data sources and steps in the described method 1300. The wide variation in bill formats make intelligent OCR a challenging task even when implemented with the assistance artificial intelligence (AI) and/or machine learning (ML). This is because an AI/ML-based intelligent OCR system must be trained how to handle bills, typically requiring samples of invoices that it is to be trained to recognize so that it can extract content with semantic meaning, such as a billed amount from the plurality of numbers present on a typically bill or invoice. Existing solutions have error rates that are too high for many merchants to accept in automated wireless payment system. The described method 1300 applies business and/or semantic logical (rules) to process the text generated by OCR without having to train the server 120 for each merchant-specific bill format, thereby avoiding the cost and complexity of other intelligent OCR systems. Once a merchant profile has been created, the method 1300 may be used without training the server 120 to recognize the bills for each merchant while having a relatively low error rate. This allows easier and faster adoption, facilitating the onboarding of merchants, while also allowing merchants to change their bill format at any time without impact to existing process.

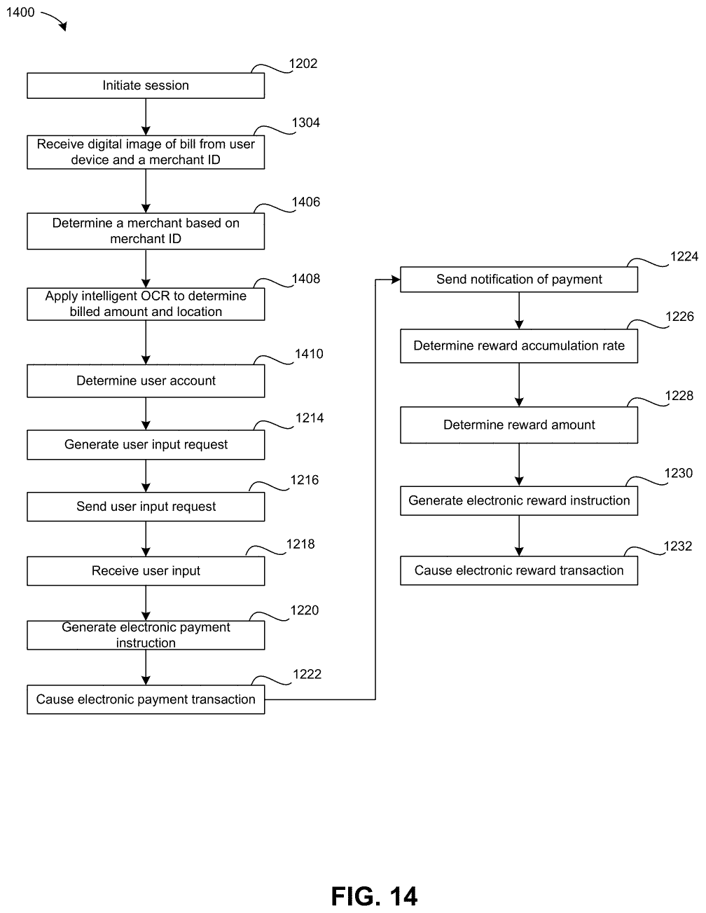

Referring now to FIG. 14, a computer-implemented method 1400 of electronic bill payment in accordance with another embodiment of the present disclosure will be described. At least parts of the method 1400 are carried out by software executed by a processor 902 of the server 120.

At step 1202, a a session is initiated on a user device 110 of a user 101 with the server 120 as described above in connection with FIG. 12.

At step 1304, the server 120 receives from the user device 110 a digital image of a bill captured by a digital camera 836 of the user device 110 and a merchant ID.

At step 1406, the server 120 determines a merchant account associated with the merchant based on the merchant ID.

At step 1408, the server 120 determines a billed amount and a location of the merchant establishment by analyzing the digital image using intelligent OCR. The determining comprised: converting, by applying OCR, the digital image into a plurality of cells, each cell comprising text; selecting a value of a cell in the plurality of cells as the billed amount based on a first designated cell in accordance with a merchant-specific bill format of the bill (which can be determined from the merchant account in the merchant database 938); and selecting a value of a cell in the plurality of cells as the location of the merchant establishment based on a second designated cell in accordance with the merchant-specific bill format of the bill. The cells generated by applying OCR may be arranged by rows and columns in some embodiments. In such embodiments, the first and second designated cells are defined by row and column. The location of the merchant establishment may be a parking lot number when the transaction relates to a parking bill or invoice, or parking ticket.

At step 1410, the server 120 determines a user account associated with the user device 110 based on the user ID. Steps 1214 to 1232 are then performed as described above in connection with FIG. 12 with the notable exception that the location of the merchant

The inventors have found that the method 1400 provides a relatively simple yet effective approach for determining billing information and accepting payment for many types of merchants when the described intelligent OCR algorithm is used in combination with the other data sources and steps in the described method 1400 and a location of a merchant establishment on the bill is desired in addition to the billing amount. The described method 1400 requires only limited knowledge about the merchant-specific bill format and does not require costly or and complex training. This allows easier and faster adoption, facilitating the onboarding of merchants, while also allowing merchants to change their bill format at any time without impact to existing process.

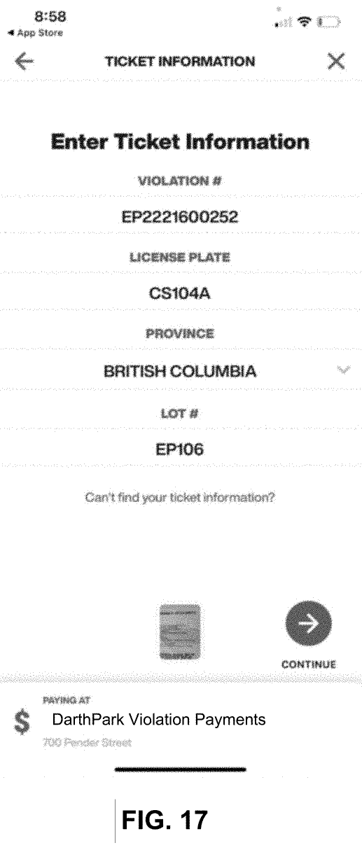

In another embodiment, the method 1400 be adapted more specifically to parking tickets (also referred to as parking infractions or violations), and applies intelligent OCR to determine from a digital image of a ticket or violation: a ticket or violation number, license plate number, a province or state of registration of the license plate, and a parking lot number as the location in addition to the infraction/violation amount, which is handled in the same manner as the billed amount for purchases. Designated cells are used to apply the intelligent OCR similar the method 1400 described above in connection with FIG. 14. Typically, the items required to process the payment of the ticket are the infraction/violation amount, ticket number, license plate number and lot number. The other data (province or state of registration) may be collective and passed to the parking infraction server if requested. FIG. 17 is an example parking ticket screen of a visual user interface of a user device in accordance with an example embodiment of the present disclosure. The parking ticket screen shows information extracted from the parking ticket with the exception of the infraction/violation amount.

In yet other embodiments, the above-noted information is determined for the parking ticket except for the infraction/violation amount, which is instead queried from a parking infraction server (not shown) using the extracted information. The parking infraction server returns the infraction/violation amount to the service provider server in response to locating a matching parking ticket. The payment of the infraction/violation amount of the parking ticket is then processed in the same manner as the billed amount for purchases as described above.

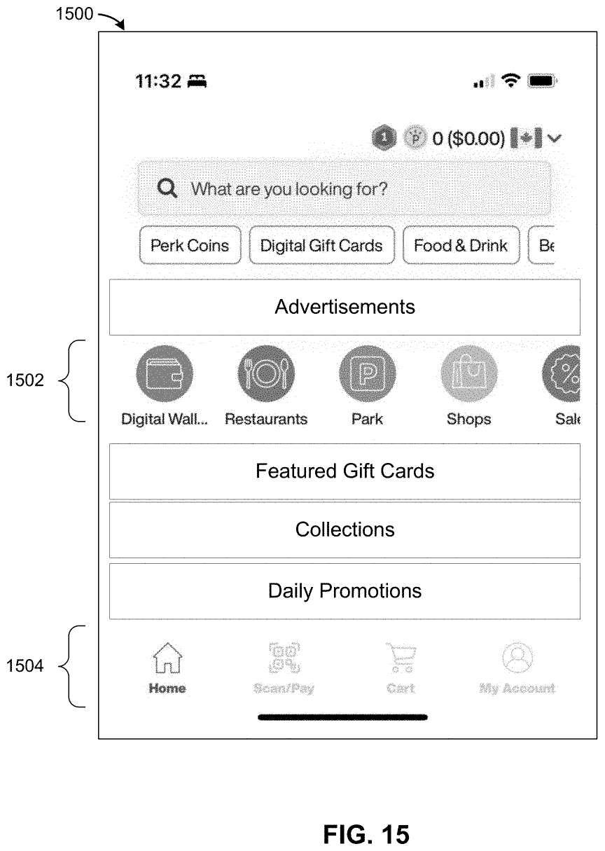

FIG. 15 is an example home screen 1500 of a visual user interface of a user device 110 in accordance with an example embodiment of the present disclosure. The home screen 1500 includes a rotatable carousel 1502 which can be navigated (rotated) by left and right swipe gestures to exposure different selectable onscreen elements of the payment application 860. Each selectable onscreen elements comprises an icon or pictogram. In the shown embodiment, the rotatable carousel 1502 comprises selectable onscreen elements for a digital wallet module, restaurant payment module, park (or parking) payment module, shops (or shopping) module, sales module, map module, history module, and refer and earn module for earning reward points for referring new users to the mobile commerce platform provided by the wireless payment systems. The shopping module can be used to purchase items in-store (e.g., by scanning a QR code of a bill or invoice, or a product tag), purchase electronic gift cards, or purchase items for shopping to home, from a variety of merchants and brands. The home screen 1500 also includes a toolbar 1504 at the bottom of the screen which includes different selectable onscreen elements, each comprising an icon or pictogram. The onscreen elements comprise a home element, a scan/pay element cart element and my account element. The selection of an onscreen element causes a different functional module of the payment application to be invoked/executed/run and a corresponding visual user interface screen displayed on the display of the user device 110.

The service provider server 120 may use the selection of an onscreen element to determine a type of input processing to be used. For example, the service provider server 120 may use the selection of the parking module to apply a first type of OCR processing to scan a document during payment of parking bills, a second type of OCR processing to scan a document during payment of parking infractions/tickets, and a third type of OCR processing to scan a document during payment of restaurant bills. Alternatively, the service provider server 120 may use a type of merchant or type of payment to determine a type of input processing to be used. For example, the service provider server 120 may use a first type of OCR processing to scan a document during payment in response to the merchant type or payment type corresponding to a parking bill, a second type of OCR processing to scan a document during payment in response to the merchant type or payment type corresponding to a parking infraction/ticket, and a third type of OCR processing to scan a document during payment in response to the merchant type or payment type corresponding to a restaurant bill.

FIG. 16 is an example restaurant screen 1600 of a visual user interface of a user device 110 in accordance with an example embodiment of the present disclosure. The restaurant screen 1600 is displayed when the restaurant module is invoked from the home screen 1500 by selecting the corresponding onscreen elements from the rotatable carousel 1502. The restaurant screen 1600 allows restaurants to be selected based on delivery options consisting of Pickup, Delivery or Table (for sit-down or in-restaurant dining). The current selected delivery option may be shown by an onscreen selection indicator 1601 which may appear as a box, caret, cursor, or colour change. The restaurant screen 1600 shows restaurants 1604 within a threshold distance of the user device 110 based on location information (e.g., GPS) about the current location of the user device 110. The restaurants 1604 may be sorted based on distance to the user device 110 from nearest to farthest, with nearest being located at the top and farthest being located at the bottom. The restaurants 1604 may be a scrollable area depending on the number of matching results.

### GENERAL

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method of electronic bill payment, comprising:
receiving, by a server from a wireless communication device, a digital image of a bill captured by a digital camera of the wireless communication device, and a location of the wireless communication device at a time at which the digital image was captured;
determining, by the server, a merchant based on the location of the wireless communication device at the time at which the digital image was captured;
determining, by the server, a merchant-specific bill format of the bill for the merchant;
determining, by the server, a billed amount by analyzing the digital image using intelligent optical character recognition (OCR) based on the merchant-specific bill format of the bill;
determining, by the server, a user account associated with the wireless communication device based on a user ID associated with a user of the wireless communication device, the user ID received from the wireless communication device;
generating, by the server, a request for user input confirming payment of the bill based on the billed amount, wherein the request causes a visual user interface (VUI) screen to be displayed on a display of the wireless communication device, the VUI including an element for receiving user input for confirming payment of the bill;
sending, by the server, the request to the wireless communication device;
receiving, by the server, user input confirming payment of the bill from the wireless communication device, the user input indicating a payment amount;
generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the payment information associated with the user account and the merchant are maintained by the server the merchant maintained by the server; and
causing the electronic payment transaction to be performed.

2. The computer-implemented method of claim 1, wherein the merchant-specific bill format of the bill is based on the merchant and the location of the wireless communication device at the time at which the digital image was captured.

3. The computer-implemented method of claim 1, wherein determining, by the server, the billed amount by analyzing the digital image using intelligent OCR based on the merchant-specific bill format of the bill, comprises:
converting, by applying OCR, the digital image into a plurality of cells, each cell comprising text; and
selecting a value of a cell in the plurality of cells as the billed amount based on a designated cell in accordance with the merchant-specific bill format.

4. The computer-implemented method of claim 3, wherein the cells generated by applying OCR are arranged by rows and columns, wherein designated cell is defined by row and column.

5. The computer-implemented method of claim 1, wherein the VUI comprises an element for specifying the payment amount from a plurality of payment options, wherein the plurality of payment options include a portion of a billed amount and an amount of a tip to be added to the billed amount based on the portion of the billed amount to be paid.

6. The computer-implemented method of claim 5, further comprising:
determining merchant rules or merchant establishment rules for the merchant;
wherein the VUI only comprises the element for specifying the payment amount from a plurality of payment options in response to a matching merchant establishment rule.

7. The computer-implemented method of claim 6, wherein the merchant establishment rules are based on the merchant and the location of a merchant establishment associated with bill.

8. The computer-implemented method of claim 1, wherein causing the electronic payment transaction to be performed comprises:
executing the electronic payment transaction.

9. The computer-implemented method of claim 1, wherein causing the electronic payment transaction to be performed comprises:
sending the electronic payment instruction to a payment processor for execution.

10. The computer-implemented method of claim 1, further comprising:
sending a notification to the merchant confirming payment of the bill.

11. The computer-implemented method of claim 10, wherein sending the notification to the merchant comprises sending an electronic message to a wireless communication device of a staff person associated with the bill.

12. The computer-implemented method of claim 11, wherein the staff person associated with the bill is determined by performing intelligent OCR based on the merchant-specific bill format of the bill.

13. The computer-implemented method of claim 1, wherein the location comprises a global positioning system (GPS) location of the wireless communication device, a location of the wireless communication device in cellular communications network, a micro-location of the wireless communication device in a retail location associated with the retailer, an identifier associated with the retail location, a user selected location, or a combination of two or more thereof.

14. The computer-implemented method of claim 1, further comprising:
subsequent to completion of the electronic payment transaction:
determining, by the server, a reward accumulation rate for the user account based on the user ID;
determining, by the server, a reward amount based on the payment amount and the reward accumulation rate;
generating, by the server, a reward transaction instruction based on the user ID and the reward amount; and
causing the reward transaction to be performed.

15. The computer-implemented method of claim 14, wherein the reward accumulation rate is based a progression level.

16. The computer-implemented method of claim 15, wherein the reward accumulation rate is based on the progression level and a purchase type.

17. A computer-implemented method of electronic bill payment, comprising:
receiving, by a server from a wireless communication device, a digital image of a bill captured by a digital camera of the wireless communication device, and a merchant identifier (ID) associated with a merchant;
determining, by the server, a billed amount by analyzing the digital image using optical character recognition (OCR) by identifying a set of all numbers present in the bill, generating a subset of numbers by removing numbers above a threshold from the set of all number present in the bill, and selecting the highest number from the subset of numbers as the billed amount;
determining, by the server, a user account associated with the wireless communication device based on a user ID associated with a user of the wireless communication device, the user ID received from the wireless communication device;
determining a merchant account associated with the merchant ID;
generating, by the server, a request for user input confirming payment of the bill based on the billed amount, wherein the request causes a visual user interface (VUI) screen to be displayed on a display of the wireless communication device, the VUI including an element for receiving user input for confirming payment of the bill;
sending, by the server, the request to the wireless communication device;
receiving, by the server, user input confirming payment of the bill from the wireless communication device, the user input indicating a payment amount;
generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the payment information associated with the user account and the merchant are maintained by the server the merchant maintained by the server; and
causing the electronic payment transaction to be performed.

18. The computer-implemented method of claim 17, wherein the threshold is based on a merchant type.

19. The computer-implemented method of claim 18, further comprising:
determining a merchant type based on the merchant ID.

20. A computer-implemented method of electronic bill payment, comprising:
receiving, by a server from a wireless communication device, a digital image of a bill captured by a digital camera of the wireless communication device, and a merchant identifier (ID) associated with a merchant;
determining, by the server, a billed amount and a location of a merchant establishment associated with the merchant by
converting the digital image into a plurality of cells applying intelligent optical character recognition (OCR), each cell comprising text,
selecting a value of a cell in the plurality of cells as the billed amount based on a first designated cell in accordance with a merchant-specific bill format of the bill, and
selecting a value of a cell in the plurality of cells as the location of the merchant establishment based on a second designated cell in accordance with the merchant-specific bill format of the bill;
determining, by the server, a user account associated with the wireless communication device based on a user ID associated with a user of the wireless communication device, the user ID received from the wireless communication device;
determining a merchant account associated with the merchant ID;
generating, by the server, a request for user input confirming payment of the bill based on the billed amount and the location determined from the bill, wherein the request causes a visual user interface (VUI) screen to be displayed on a display of the wireless communication device, the VUI including an element for receiving user input for confirming payment of the bill;
sending, by the server, the request to the wireless communication device;
receiving, by the server, user input confirming payment of the bill from the wireless communication device, the user input indicating a payment amount;
generating, by the server, an electronic payment instruction in response to receiving user input confirming payment of the bill from the wireless communication device, the electronic payment instruction being based on payment information associated with the user account, payment information associated with a merchant account of the merchant and the payment amount, wherein the electronic payment instruction includes the location of the merchant establishment determined from the bill, wherein the payment information associated with the user account and the merchant are maintained by the server the merchant maintained by the server; and
causing the electronic payment transaction to be performed.
